(19) United States
(12) Patent Application Publication
(10) Pub. No.: US 2025/0376234 A1
(43) Pub. Date: Dec. 11, 2025

(54) TRAVELING-DATA-OUTPUT DEVICE, TRAVELING-DATA-MEASURING DEVICE, TRAVELING-DATA-MEASURING-AND-OUTPUT DEVICE, AND LEANING-VEHICLE-DATA-PROCESSING DEVICE

(71) Applicant: YAMAHA HATSUDOKI KABUSHIKI KAISHA, Iwata-shi (JP)

(72) Inventors: Seigo NAGAYA, Shizuoka (JP); Jian Hong LEE, Shizuoka (JP); Keisuke MORISHIMA, Shizuoka (JP)

(21) Appl. No.: 19/307,405

(22) Filed: Aug. 22, 2025

Related U.S. Application Data
(63) Continuation-in-part of application No. PCT/JP2023/006826, filed on Feb. 24, 2023.

(51) Int. Cl. B62J 50/22; B62J 45/412; B62J 45/414

(52) U.S. Cl. CPC B62J 50/22; B62J 45/412; B62J 45/414

(57) ABSTRACT

A traveling-data-output device, including a traveling-data-output processor configured to: acquire time-series-traveling data output in a time-series manner from a detection device freely mounted to a mobile object of a first coordinate system for a speed change cycle, the time-series-traveling data including speed data of the mobile object, acceleration data in three directions in a second coordinate system, and angular velocity data about three coordinate axes in a third coordinate system, and perform coordinate system conversion on the acquired time-series-traveling data for at least the speed change cycle to convert the second and third coordinate systems to the first coordinate system and output the resulting time-series-traveling data. The three coordinate axes in the first to third coordinate systems are parallel to or coincident with one another, and a front-rear direction, a top-bottom direction, and a left-right direction of the acceleration sensor, the angular velocity sensor and the mobile object are aligned.

### CROSS-REFERENCE TO RELATED APPLICATIONS

This is a continuation-in-part application of International Application No. PCT/JP2023/006826, filed on Feb. 24, 2023, the contents of which are incorporated herein by reference.

### TECHNICAL FIELD

The present teaching relates to a traveling-data-output device, a traveling-data-measuring device, a traveling-data-measuring-and-output device, and a leaning-vehicle-data-processing device.

### BACKGROUND ART

There is known a sensor that is mounted on a leaning vehicle configured to lean leftward when turning to the left and lean rightward when turning to the right, and detects a physical quantity related to a behavior of the leaning vehicle. Non-patent Document 1, for example, discloses that a portable terminal incorporating the sensor is attached to a steering wheel of a leaning vehicle to thereby detect a physical quantity related to a behavior of the leaning vehicle.

In the configuration disclosed in the Non-patent Document 1, it is required to firmly fix the portable terminal to the steering wheel or the periphery thereof in the leaning vehicle in a mounting posture instructed in advance such that the screen of the portable terminal is as perpendicular to the road as possible and the portable terminal is prevented from tilting left or right.

Patent Document 1 discloses a technique for determining whether a measuring device incorporating a sensor for detecting a physical quantity related to a behavior of a leaning vehicle is appropriately attached to the leaning vehicle. In other words, Patent Document 1 discloses that the measuring device needs to be attached to the leaning vehicle in a mounting posture instructed in advance.

Patent Document 2, for example, discloses a behavior-information-estimating method for estimating behavior information of the leaning vehicle capable of traveling in a leaning state and including a stand member for allowing the leaning vehicle to stand by itself and stop in a leaning state by using a three-axis-acceleration sensor. In a stationary-measurement-value-acquisition step in Patent Document 2, an acceleration measured value is acquired by the three-axis-acceleration sensor in two states of an upright stationary state in which the leaning vehicle is stationary in an upright state before traveling starts and a stationary leaning state in which the leaning vehicle is stationary in a leaning state using the stand member. In the behavior-information-estimating method, an acceleration measured value of the three-axis-acceleration sensor is converted to be matched with a vehicle coordinate system defined in advance for the leaning vehicle, based on an acceleration measured value measured in a posture of the leaning vehicle instructed in advance before the start of traveling.

### CITATION LIST

### Patent Documents

Patent Document 1: Japanese Patent Application Publication No. 2019-100821
Patent Document 2: Japanese Patent Application Publication No. 2020-104786

### Non-Patent Document

Non-patent Document 1: “YAMAHA SR,” YAMAHA HATSUDOKI KABUSHIKI KAISHA, [searched on May 18, 2021], Internet (https://www.yamaha-motor.co.jp/mc/life/apps/smartriding/faq/#c002)

### SUMMARY OF INVENTION

### Technical Problem

In the configurations disclosed in Non-patent Document 1 and Patent Document 1 described above, to increase detection accuracy of a physical quantity related to a behavior of the leaning vehicle, a mounting posture of the sensor mounted by an installer relative to the leaning vehicle needs to be matched with a mounting posture instructed in advance.

However, the mounting posture of the sensor relative to the leaning vehicle depends on an attachment action of the installer who mounts the sensor on the leaning vehicle. Thus, it is difficult to completely match the mounting posture of the sensor relative to the leaning vehicle with the mounting posture instructed in advance. As a result, the detection accuracy of the physical quantity related to the behavior of the leaning vehicle depends on the action of the installer. It is therefore difficult to enhance detection accuracy of the physical quantity related to the behavior of the leaning vehicle.

In the method disclosed in Patent Document 2, measured values of acceleration and angular velocity are acquired by the three-axis-acceleration sensor and an angular velocity sensor in the two states of the upright stationary state and the stationary leaning state of the vehicle before the start of traveling. In the behavior-information-estimating method of Patent Document 2, as disclosed in paragraphs and of Patent Document 2, a user is instructed to maintain the “state in which the steering wheel is directed straight forward” in the two states of the upright stationary state and the inclined stationary state of the vehicle. This is in order to acquire measured values in the two states in which only the posture of the vehicle in the roll direction is changed without changing the posture in the pitch direction and the yaw direction.

However, to direct the steering wheel straight forward in the stationary leaning state, a skill of the installer is required. This is because a leaning vehicle is generally designed to have a self-steering function in a vehicle configuration thereof, and thus, when the leaning vehicle is caused to lean, the steering wheel is naturally steered. Therefore, in the behavior-information-estimating method of Patent Document 2, since the posture of the leaning vehicle on which the sensor for measuring an acceleration before the start of traveling depends on an action of the installer, it is difficult to match the posture of the leaning vehicle with the posture of the leaning vehicle instructed in advance. Accordingly, in the behavior-information-estimating method of Patent Document 2, it is difficult to enhance detection accuracy of the physical quantity related to the behavior of the leaning vehicle.

It is therefore an object of the present teaching to provide a traveling-data-output device, a traveling-data-measuring device, a traveling-data-measuring-and-output device, and a leaning-vehicle-data-processing device capable of acquiring highly accurate traveling data independently of an action of an installer who mounts a detection device on a mobile object.

### Solution to Problem

Inventors of the present teaching studied traveling data of a leaning vehicle in detail to acquire highly accurate traveling data independently of an action of an installer who mounts a detection device on a mobile object.

Unlike a four-wheeled vehicle, a vehicle body of a leaning vehicle leans leftward when turning to the left and leans rightward when turning to the right. In addition, since the leaning vehicle has a smaller vehicle width than the four-wheeled vehicle, even when the leaning vehicle travels in a straight lane, the leaning vehicle might move in the left direction or in the right direction in the same lane. For example, the leaning vehicle may travel toward the right side within the same lane in order to make a right turn at an intersection, or travel toward the left within the same lane in order to make a left turn at an intersection. Further, it is expected that when the leaning vehicle is traveling in the center of a lane and a manhole or the like is located in the center of the lane, the leaning vehicle may avoid the manhole or the like by shifting to the left side or the right side within the same lane and then return to the center of the lane. As compared to a four-wheeled vehicle, the leaning vehicle leans significantly in the left direction or in the right direction during such an in-lane path change or the like. In contrast, in the four-wheeled vehicle, even when such an in-lane path change or the like is performed, the vehicle body hardly leans in the left direction or in the right direction.

When the vehicle body leans due to such an in-lane path change of the leaning vehicle or the like, the leftward or rightward leaning behavior of the leaning vehicle body appears in sensor output data of the sensor mounted on the leaning vehicle, even though the leaning vehicle is traveling within the same lane.

As described above, in the conventional techniques of Non-patent Document 1, Patent Document 1, and Patent Document 2, for example, it is required to match the mounting posture of the sensor mounted by the installer before the start of traveling relative to the leaning vehicle with the mounting posture instructed in advance, or it is required to match the posture of the leaning vehicle on which the sensor is mounted with the posture of the leaning vehicle instructed in advance in measuring an acceleration before the start of traveling. The inventors of the present teaching considered that since sensor output data in the leaning vehicle during traveling has characteristics as described above, the mounting posture of the sensor or the posture of the leaning vehicle is required as described above in the conventional techniques described above.

The inventors of the present teaching also found that since the sensor output data in the leaning vehicle during traveling has the above-described characteristics, it is difficult to employ, to the leaning vehicle, a sensor-output-data-processing technique for four-wheeled vehicles as studied for sensor output data in the four-wheeled vehicles.

From the above consideration, the inventors studied the traveling data of the leaning vehicle in more details in order to acquire highly accurate traveling data independently of an action of an installer who mounts a detection device on a mobile object.

Depending on application of the sensor output data in the leaning vehicle, a certain amount of data measured by a sensor may be required in some cases. For example, a certain amount of data is required to ensure accuracy in the case of calculating an insurance rate of a leaning vehicle and the case of evaluating a driver's skill.

To accumulate a certain amount of data, it is assumed that the leaning vehicle travels a distance corresponding to the amount of data. Further, it is assumed that the traveling state of the leaning vehicle before a certain amount of data is accumulated includes both a straight scene and a turning scene. The turning scene includes a left turn and a right turn at an intersection. Accordingly, when a certain amount of data is accumulated, it becomes easy to grasp the tendency of the traveling state of the leaning vehicle.

The sensor output data in the certain amount of data only needs to include sensor output data for a speed change cycle. The speed change cycle means one cycle of a speed change of the leaning vehicle in a period from when the mobile object posture and the mobile object speed in the front-rear direction of the leaning vehicle change from a predetermined state to when the mobile object posture and the mobile object speed in the front-rear direction return to the predetermined state.

If coordinate system alignment can be performed to align a sensor coordinate system having three coordinate axes with the mobile object coordinate system in a state where the conditions described above are satisfied, adjustment of the mounting posture of the sensor in advance and calibration of the sensor can be omitted.

When the coordinate systems can be accurately aligned without adjustment of the mounting posture of the sensor and calibration of the sensor in advance as described above, convenience of a user can be enhanced.

Although the above description is a result of the study conducted on the leaning vehicle, the inventors of the present teaching further conducted study to find that the above study is also applicable to other mobile objects. This is because of the following reasons. As described above, in a leaning vehicle, a roll behavior of a vehicle body is prominently reflected in sensor data during turning. On the other hand, in a four-wheeled vehicle, the roll behavior is less likely to appear as prominently in the sensor output data as in the case of the leaning vehicle during turning. Therefore, it is easier to separate traveling scenes in traveling data of the four-wheeled vehicle than in the case of the leaning vehicle. Accordingly, the above considerations are also applicable to mobile objects that exhibit smaller roll behaviors such as four-wheeled vehicles. It should be noted that the above considerations are also applicable not only to land-based mobile objects but also to mobile objects that travel on water, underwater, or in the air.

Through intensive studies as described above, the inventors of the present teaching have conceived the following configurations as a traveling-data-output device for outputting traveling data based on detection data of the sensor in order to acquire highly accurate traveling data while enhancing convenience of a user.

A traveling-data-output device according to one embodiment of the present teaching is configured to output traveling data of a first coordinate system, which is a coordinate system of a mobile object based on an output of a detection device that is mounted and fixed to the mobile object by an installer and that detects a physical quantity related to a behavior of the mobile object, wherein the detection device includes: an acceleration sensor configured to output accelerations in three directions respectively in three coordinate axes of a second coordinate system, which is a coordinate system of the acceleration sensor, the acceleration sensor being mounted on the mobile object in a first mounting posture according to a free will of the installer rather than in a predetermined first mounting posture instructed in advance, and an angular velocity sensor configured to output angular velocities about three coordinate axes of a third coordinate system, which is a coordinate system of the angular velocity sensor, the angular velocity sensor being mounted on the mobile object in a second mounting posture thereof according to the free will of the installer rather than in a predetermined second mounting posture instructed in advance. The traveling-data-output device includes: a traveling-data-output processor configured to execute program instructions to: acquire at least time-series-traveling data that is output in a time-series manner from the detection device for a speed change cycle, the speed change cycle being from when a posture of the mobile object and a speed of the mobile object in a front-rear direction of the mobile object change from a predetermined state to when the posture and the speed of the mobile object in the front-rear direction return to the predetermined state while the mobile object is traveling in the posture at the speed according to the free will of the installer rather than in a predetermined posture and at a predetermined speed instructed in advance, the time-series-traveling data including: speed data of the mobile object, acceleration data in the three directions in the second coordinate system, and angular velocity data about the three coordinate axes in the third coordinate system, and perform coordinate system conversion on the acquired time-series-traveling data for at least the speed change cycle to convert the second and third coordinate systems to the first coordinate system and output the resulting time-series-traveling data, by using at least both the time-series-traveling data when the posture and the speed of the mobile object in the front-rear direction change from the predetermined state and the time-series-traveling data when the posture and the speed of mobile object in the front-rear direction return to the predetermined state, in the acquired time-series-traveling data for the speed change cycle, such that the three coordinate axes in each of the second and third coordinate systems are made parallel to or coincident with three coordinate axes in the first coordinate system, and a front-rear direction, a top-bottom direction, and a left-right direction relative to each of the acceleration sensor and the angular velocity sensor are aligned with the front-rear direction, a top-bottom direction, and a left-right direction relative to the mobile object, whereby the coordinate system conversion is performed based on the acquired time-series-traveling data for at least the speed change cycle acquired during traveling in the posture at the speed according to the free will of the installer by the detection device mounted in the first and second mounting postures according to the free will of the installer, unlike data acquired by the detection device mounted in the predetermined first and second mounting postures instructed in advance and data acquired by the detection device before start of traveling in the predetermined posture instructed in advance.

In the configuration described above, at least the time-series-traveling data for the speed change cycle from when the mobile object posture and the mobile object speed in the front-rear direction change from the predetermined state to when the mobile object posture and the mobile object speed in the front-rear direction return to the predetermined state is acquired. The thus-acquired time-series-traveling data for the speed change cycle includes both time-series-traveling data when the mobile object posture and the mobile object speed in the front-rear direction change from the predetermined state and time-series-traveling data when the mobile object posture and the mobile object speed in the front-rear direction return to the predetermined state. In other words, the thus-acquired time-series-traveling data for the speed change cycle includes the time-series-traveling data in different postures, different acceleration states, and different deceleration states. In addition, since the time-series-traveling data is consecutive data groups, computation and statistics processing of the time-series-traveling data are easy. Accordingly, by using accelerations included in the time-series-traveling data for at least the speed change cycle, for example, a yaw axis (Z axis) in the coordinate system of the mobile object can be easily estimated. In addition, by using the speed and the angular velocity included in the time-series-traveling data for at least the speed change cycle, for example, scenes such as a straight traveling scene and/or a turning scene of the mobile object can be easily estimated. Further, by using the speed and the acceleration included in the time-series-traveling data for at least the speed change cycle, for example, the front-rear direction of the mobile object can be easily estimated. The predetermined state may be an extremely low-speed state or a stopped state of the mobile object.

Since batch processing is performed on a certain amount of data, both accuracy and convenience can be achieved. That is, in acquiring traveling data of the mobile object, the certain amount of data enables conversion of the time-series-traveling data in the coordinate systems of the sensors to the time-series-traveling data in the coordinate system of the mobile object without assumption that the sensor is attached to the mobile object in a mounting posture instructed in advance and special operation such as calibration of the attached sensor.

Accordingly, it is possible to provide a traveling-data-output device capable of acquiring highly accurate traveling data independently of an action of an installer who mounts the detection device on the mobile object.

In another aspect, the traveling-data-output device according to the present teaching may include the following configuration. The traveling-data-output processor makes a sensor-coordinate-system-first axis that is one of the three coordinate axes in the second or third coordinate system parallel to or coincident with a mobile-object-coordinate-system-first axis that is one of the three coordinate axes in the first coordinate system.

In the configuration described above, flexibility of the conversion process of time-series-traveling data can be reduced, and thus, the conversion process of the time-series-traveling data can be easily performed.

In another aspect, the traveling-data-output device according to the present teaching may include the following configuration. The traveling-data-output processor aligns a direction relative to the sensor in the sensor-coordinate-system-first axis with a direction relative to the mobile object in the mobile-object-coordinate-system-first axis in a state where the sensor-coordinate-system-first axis is made parallel to or coincident with the mobile-object-coordinate-system-first axis.

In the configuration described above, flexibility of the conversion process of time-series-traveling data can be reduced, and thus, the conversion process of the time-series-traveling data can be easily performed.

In another aspect, the traveling-data-output device according to the present teaching may include the following configuration. The traveling-data-output processor makes remaining coordinate axes other than the sensor-coordinate-system-first axis in the three coordinate axes in the second or third coordinate system parallel to or coincident with remaining coordinate axes other than the mobile-object-coordinate-system-first axis in the three coordinate axes in the first coordinate system, respectively, and aligns directions relative to the sensors in the remaining coordinate axes other than the sensor-coordinate-system-first axis with directions relative to the mobile object in the remaining coordinate axes other than the mobile-object-coordinate-system-first axis, respectively, in a state where the sensor-coordinate-system-first axis is made parallel to or coincident with the mobile-object-coordinate-system-first axis and the direction relative to the sensors in the sensor-coordinate-system-first axis is aligned with the direction relative to the mobile object in the mobile-object-coordinate-system-first axis.

In the configuration described above, the sensor-coordinate-system-first axis and the direction thereof in the three coordinate axes in the sensor coordinate system to be processed are defined relative to the mobile-object-coordinate-system-first axis. Thus, flexibility in the conversion process can be reduced accordingly. This makes the conversion process of the remaining coordinate axes easier.

In another aspect, the traveling-data-output device according to the present teaching may include the following configuration. The traveling-data-output processor makes remaining coordinate axes other than the sensor-coordinate-system-first axis in the three coordinate axes in the second or third coordinate system parallel to or coincident with remaining coordinate axes other than the mobile-object-coordinate-system-first axis in the three coordinate axes in the first coordinate system in a state where the sensor-coordinate-system-first axis is made parallel to or coincident with the mobile-object-coordinate-system-first axis.

In the configuration described above, first, axial alignment is performed on one coordinate axis, and then on the remaining coordinate axes. This makes calculation easier than in the case of performing axial alignment on the three coordinate axes collectively.

In another aspect, the traveling-data-output device according to the present teaching may include the following configuration. The mobile-object-coordinate-system-first axis is a top-bottom axis extending in the top-bottom direction in the first coordinate system or a front-rear axis extending in the front-rear direction in the first coordinate system.

In the configuration described above, the top-bottom axis in the coordinate system of the mobile object corresponds to the gravity direction, and the front-rear axis in the coordinate system of the mobile object corresponds to the traveling direction. By using the gravity direction or the traveling direction as a reference in this manner, the sensor coordinate system can be easily aligned with the gravity direction of the mobile object or the front-rear direction of the mobile object.

In another aspect, the traveling-data-output device according to the present teaching may include the following configuration. The mobile-object-coordinate-system-first axis is a top-bottom axis extending in the top-bottom direction in the first coordinate system, and the traveling-data-output processor makes a sensor-coordinate-system-second axis that is one of the remaining coordinate axes in the second or third coordinate system parallel to or coincident with a front-rear axis extending in the front-rear direction in the first coordinate system, whereby a direction of the sensor-coordinate-system-second axis is aligned with a direction of the front-rear axis in the first coordinate system in a state where the sensor-coordinate-system-first axis is made parallel to or coincident with the top-bottom axis in the first coordinate system, and the direction of the sensor-coordinate-system-first axis is aligned with a direction of the top-bottom axis in the first coordinate system.

In the configuration described above, first, the traveling-data-output processor specifies the top-bottom axis and the direction of the top-bottom axis. The top-bottom axis in the coordinate system of the mobile object corresponds to the gravity direction. By using the gravity direction as a reference in this manner, the sensor coordinate system is easily aligned with the top-bottom axis of the mobile object, and a direction relative to the sensor is easily aligned with a direction relative to the mobile object.

It is sufficient that after the top-bottom axis and the direction of the top-bottom axis of the mobile object are specified, the remaining left-right axis and front-rear axis are aligned. At this time, the use of the time-series-traveling data for the speed change cycle also eases specification of the front-rear axis and the direction of the front-rear axis in the coordinate system of the mobile object.

Accordingly, efficiency and accuracy of the conversion process on the coordinate axes are enhanced.

A traveling-data-measuring device for the traveling-data-output device according to one embodiment of the present teaching may include the following configuration. The traveling-data-measuring device is configured to be mountable on the mobile object and measure the time-series-traveling data for at least the speed change cycle for use in the coordinate system conversion. The traveling-data-measuring device includes: the detection device including the acceleration sensor and the angular velocity sensor; and a measurement processor. The measurement processor is configured to execute other program instructions to: acquire the time-series-traveling data in the time-series manner from the detection device, including: the speed data of the mobile object, the acceleration data in the three coordinate axial directions in the second coordinate system, and the angular velocity data about the three coordinate axes in the third coordinate system, while the mobile object is traveling in the posture at the speed according to the free will of the installer rather than in the predetermined posture and at the predetermined speed instructed in advance, in a state where the traveling-data-measuring device is mounted on the mobile object in a third mounting posture according to the free will of the installer rather than in a predetermined third mounting posture instructed in advance by the installer, and output the time-series-traveling data of at least the speed change cycle from when the posture and the speed of the mobile object in the front-rear direction change from the predetermined state to when the posture and the speed in the front-rear direction return to the predetermined state while the mobile object is traveling in the posture at the speed according to the free will of the installer rather than in the predetermined posture and at the predetermined speed instructed in advance, in the acquired time-series-traveling data, in a format in which the second and third coordinate systems are allowed to be subjected to coordinate system conversion by the traveling-data-output processor of the traveling-data-output device, rather than in a format in which the time-series-traveling data is subjected to coordinate system conversion to convert the second and third coordinate systems to the first coordinate system.

In the configuration described above, time-series-traveling data can be output in the format that enables coordinate system conversion by the traveling-data-output processor of the traveling-data-output device. Accordingly, the traveling-data-measuring device is capable of outputting time-series-traveling data suitable for a coordinate-system-conversion process of the traveling-data-output device.

In addition, in the configuration described above, it is possible to provide the traveling-data-output device capable of acquiring high accurate traveling data independently of an action of an installer who mounts the detection device on the mobile object.

In another aspect, the traveling-data-measuring device according to the present teaching may include the following configuration. The traveling-data-measuring device further includes a communication device configured to communicate with outside, wherein the measurement processor outputs, to outside of the traveling-data-measuring device via the communication device, the time-series-traveling data.

The configuration described above can provide the traveling-data-measuring device for supplying the time-series-traveling data to the traveling-data-output device that performs a coordinate conversion process. Accordingly, the traveling-data-measuring device and the traveling-data-output device can be implemented by different devices. Thus, the present teaching can be achieved by different devices.

In another aspect, the traveling-data-output device according to the present teaching may include the following configuration. The traveling-data-output device further includes a communication device configured to communicate with outside, wherein the traveling-data-output processor acquires the time-series-traveling data for at least the speed change cycle via the communication device.

The configuration described above can provide the traveling-data-output device that performs the coordinate conversion process based on the time-series-traveling data supplied from the traveling-data-measuring device. Accordingly, the traveling-data-measuring device and the traveling-data-output device can be implemented by different devices. Thus, the present teaching can also be achieved by different devices.

A traveling-data-measuring-and-output device according to one embodiment of the present teaching may include the following configuration. The traveling-data-measuring-and-output device is configured to output traveling data of a first coordinate system, which is a coordinate system of a mobile object, based on an output of a detection device that is mounted and fixed to the mobile object by an installer and that detects a physical quantity related to a behavior of the mobile object, wherein the detection device includes: an acceleration sensor configured to output accelerations in three directions respectively in three coordinate axes of a second coordinate system, which is a coordinate system of the acceleration sensor, the acceleration sensor being mounted on the mobile object in a first mounting posture according to a free will of the installer rather than in a predetermined first mounting posture instructed in advance, and an angular velocity sensor configured to output angular velocities about three coordinate axes of a third coordinate system, which is a coordinate system of the angular velocity sensor, the angular velocity sensor being mounted on the mobile object in a second mounting posture thereof according to the free will of the installer rather than in a predetermined second mounting posture instructed in advance. The traveling-data-measuring-and-output device includes: a processor that is electrically connected to a memory and housed in a casing mounted on a mobile object. The processor is configured to execute program instructions to: acquire time-series-traveling data that is output in a time-series manner from the detection device, the time-series-traveling data including speed data of the mobile object, acceleration data in the three directions of the second coordinate system, and angular velocity data about the three coordinate axes of the third coordinate system, while the mobile object is traveling in a posture at a speed according to the free will of an installer rather than in a predetermined posture and at a predetermined speed instructed in advance, in a state where the casing is mounted on the mobile object in a third mounting posture according to the free will of the installer rather than in a predetermined third mounting posture instructed in advance by the installer, output, to the memory, the time-series-traveling data including data for at least a speed change cycle, which is from when a posture and a speed of the mobile object in a front-rear direction change from a predetermined state to when the posture and the speed of the mobile object in the front-rear direction return to the predetermined state, while the mobile object is traveling in the posture at the speed according to the free will of the installer rather than in the predetermined posture and at the predetermined speed instructed in advance in the acquired time-series-traveling data, in a format in which the second and third coordinate systems are allowed to be subjected to coordinate system conversion by the processor, rather than in a format in which the time-series-traveling data is subjected to coordinate system conversion to convert the second and third coordinate systems to the first coordinate system, acquires the time-series-traveling data for at least the speed change cycle from the memory, and perform the coordinate system conversion on the acquired time-series-traveling data for at least the speed change cycle to convert the second and third coordinate systems to the first coordinate system and output the time-series-traveling data, by using both the time-series-traveling data when the posture and the speed of the mobile object in the front-rear direction change from the predetermined state and the time-series-traveling data when the posture and the speed of the mobile object in the front-rear direction return to the predetermined state in the acquired time-series-traveling data for at least the speed change cycle, such that the three coordinate axes in each of the second and third coordinate systems are made parallel to or coincident with the three coordinate axes in the first coordinate system, and a front-rear direction, a top-bottom direction, and a left-right direction relative to each of the acceleration sensor and the angular velocity sensor are aligned with the front-rear direction, a top-bottom direction, and a left-right direction relative to the mobile object, whereby the coordinate system conversion is performed based on the acquired time-series-traveling data for at least the speed change cycle acquired during traveling in the posture at the speed according to the free will of the installer by the detection device mounted in the first and second mounting postures according to the free will of the installer, unlike data acquired by the detection device mounted in the predetermined first and second mounting postures instructed in advance and data acquired by the detection device acquired before start of traveling in the predetermined posture instructed in advance.

The configuration described above can provide the traveling-data-measuring-and-output device having both the function of the traveling-data-output device and the function of the traveling-data-measuring device. Accordingly, the coordinate conversion process can be performed by the traveling-data-measuring-and-output device alone. In addition, without the need to communicate between the traveling-data-measuring device and the traveling-data-output device, influence of the network can thus be avoided.

A leaning-vehicle-data-processing device according to one embodiment of the present teaching preferably includes the following configuration. The leaning-vehicle-data-processing device includes the traveling-data-measuring-and-output device. In the leaning-vehicle-data-processing device, the mobile object includes a leaning vehicle having a vehicle body that leans leftward when turning to left and leans rightward when turning to right, the time-series-traveling data for at least the speed change cycle acquired by the traveling-data-output processor and used for coordinate system conversion is time-series-traveling data for a speed change cycle acquired while the mobile object is traveling in the posture at the speed according to the free will of the installer rather than in the predetermined posture and at the predetermined speed instructed in advance and from when the posture of the mobile object including at least a leaning posture related to a left-right direction of the mobile object and the speed in the front-rear direction change from the predetermined state to when the posture and the speed return to the predetermined state, and the coordinate system conversion is performed by using the time-series-traveling data for at least the speed change cycle including at least a change of the leaning posture related to the left-right direction of the mobile object.

In the leaning vehicle, in a case where the vehicle body leans due to an in-lane path change or the like, a leaning behavior in the left direction or in the right direction of the vehicle body of the leaning vehicle appears in time-series-traveling data output from the detection device mounted on the vehicle, even though the leaning vehicle is traveling within the same lane. In the configuration described above, highly accurate traveling data can be acquired in accordance with characteristics of the time-series-traveling data in the leaning vehicle, independently of an action of the installer who mounts the detection device on the leaning vehicle.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification, specify the presence of stated features, steps, operations, elements, components, and/or their equivalents but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention.

Embodiments of a traveling-data-output device according to the present teaching will be herein described.

In the following description, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

### [Leaning Vehicle]

A leaning vehicle herein is a vehicle that turns in a leaning posture. Specifically, the leaning vehicle is a vehicle that leans leftward when turning to the left and leans rightward when turning to the right, in the left-right direction of the vehicle. The leaning vehicle may be a single-passenger vehicle or a vehicle on which a plurality of passengers can ride. The leaning vehicle includes vehicles such as a three-wheeled vehicle or a four-wheeled vehicle, as well as a two-wheeled vehicle. That is, the leaning vehicle is not limited in the number of wheels and the presence or absence of wheels, and includes all the types of vehicles that turn in leaning postures. The leaning vehicle includes a scooter and the like.

### [Mobile Object]

A mobile object herein refers to a device including a moving mechanism for moving in a space. The moving mechanism includes a device driven by human power and a device including a power unit such as an engine or a motor. The mobile object may include wheels as a moving mechanism, or may be configured without wheels. The mobile object includes a land-based mobile object, a waterborne mobile object, an underwater mobile object, and an airborne mobile object. The mobile object also includes not only a mobile object operated by a pilot or a driver, but also a mobile object that moves autonomously.

The land-based mobile object includes a two-wheeled vehicle (e.g., a motorcycle and a bicycle) and a four-wheeled vehicle (e.g., an automobile). The land-based mobile object also includes a device including wheels, an endless track, and other ground moving mechanisms. The land-based mobile object includes a snow bike that moves on snow. The land-based mobile object may include a moving mechanism other than wheels, such as skis.

The waterborne mobile object includes a small ship and a large ship. The waterborne mobile object includes a mobile object that moves on the sea.

The underwater mobile object includes a submarine and a remotely operated vehicle (ROV).

The airborne mobile object includes an aircraft and a so-called unmanned aircraft such as a drone.

The mobile object also includes an artificial satellite or a spacecraft that moves on a satellite orbit in a gravitational sphere.

The mobile object herein may particularly refer to a mobile object which travels in one direction and in which gravity acts downward along the top-bottom axis of the moving body in a straight-traveling state at both the start and the end of movement.

### [Three Coordinate Axes]

Three coordinate axes herein refer to three axes of an X axis, a Y axis, and a Z axis that are orthogonal to each other. The three coordinate axes are coordinate axes in a case where a reference object is located at an origin. For example, a coordinate system of a sensor is configured by three coordinate axes relative to the sensor. For example, a coordinate system of a mobile object is configured by three coordinate axes relative to the mobile object. In the case of a mobile object, three coordinate axes are also referred to as a roll axis extending in the front-rear direction relative to a vehicle, a pitch axis extending in the left-right direction relative to the vehicle, and a yaw axis extending in the vertical direction relative to the vehicle.

### [Coordinate System of Mobile Object]

A coordinate system of a mobile object herein includes a coordinate system of a mobile object in design, but is not limited thereto. The coordinate system includes a coordinate system of a mobile object estimated based on traveling characteristics indicated by traveling data. In other words, the coordinate system of the mobile object includes a coordinate system approximated to the coordinate system of the mobile object in design.

### [Physical Quantity Related to Behavior of Mobile Object]

A physical quantity related to a behavior of a mobile object herein refers to a physical quantity that changes due to a posture or a motion of the mobile object. The physical quantity related to a behavior of the mobile object includes at least one of a velocity, an acceleration, a deceleration, an angle, an angular velocity, or an angular acceleration, wherein the velocity, acceleration, and deceleration are measured in the three axial directions (“front-rear direction,” “left-right direction,” and “top-bottom direction”) of the mobile object, and the angle, angular velocity, and angular acceleration are measured about three axes (roll axis, yaw axis, and pitch axis) of the mobile object.

### [Physical Quantity]

A physical quantity herein is a physical quantity including at least one of a physical quantity related to a roll motion of a mobile object, a physical quantity related to a yaw motion of the mobile object, or a physical quantity related to a pitch motion of the mobile object, acquired while the mobile object is traveling. The physical quantity is related to at least one of rolling, yawing, or pitching, and is data including at least one type of information of a speed, an acceleration, a jerk, an angle, an angular velocity, an angular acceleration, positional information, or other type of information.

### [Traveling Data]

Traveling data herein is data related to traveling of a mobile object. The traveling data includes data based on an output of a sensor that detects a physical quantity related to a behavior of the mobile object. The traveling data may include at least one of mobile-object-driving-input data related to a driving input of a driver to the mobile object, mobile-object-behavior data related to a behavior of the mobile object, mobile-object-position data related to a traveling position of the mobile object, or mobile-object-traveling-environment data related to a traveling environment where the mobile object travels.

### [Time-Series-Traveling Data]

Time-series-traveling data herein refers to traveling data that is output in a time-series manner. The expression “output in a time-series manner” means that the data is output in chronological order according to time. That is, the time-series-traveling data includes information combining traveling data and a time at which the traveling data was output.

### [Direction Relative to Target Object]

A direction relative to a target object herein refers to a direction as viewed from the target object. In a case where the target object is a mobile object, this direction is a direction as viewed from the mobile object. For example, in a case where the mobile object is a leaning vehicle, the direction is a direction as viewed from a driver on the leaning vehicle. In a case where the target object is a sensor, the direction is a direction as viewed from the sensor.

### [Direction of Coordinate Axis]

A direction of a coordinate axis herein refers to a positive or negative direction of the coordinate axis. Aligning the directions of two coordinate axes means, for example, aligning the positive directions of the two coordinate axes.

### [Accelerations in Three Coordinate Axial Directions]

Accelerations in three coordinate axial directions herein refer to accelerations in directions parallel to the three axes (X axis, Y axis, and Z axis) of a coordinate system relative to a target object. In a case where the target object is, for example, a mobile object, the accelerations in the three coordinate axial directions refer to accelerations of the mobile object in the three axial directions of the “front-rear direction,” the “left-right direction,” and the “top-bottom direction.” The three coordinate axial directions refer to directions along which the X axis, the Y axis, and the Z axis extend, respectively.

[Angular Velocities about Three Coordinate Axes]

Angular velocities about three coordinate axes herein refer to angular velocities when a target object rotates about the three axes (X axis, Y axis, and Z axis), respectively, of a coordinate system relative to the target object. In a case where the target object is, for example, a mobile object, the angular velocities about the three coordinate axes refer to angular velocities when the mobile object rotates about the roll axis, the pitch axis, and the yaw axis.

### [Speed Change Cycle]

A speed change cycle herein refers to one cycle of a speed change of the mobile object in a period from when the mobile object posture and the mobile object speed in the front-rear direction change from a predetermined state to when the mobile object posture and the mobile object speed in the front-rear direction return to the predetermined state during driving. The mobile object posture may be defined relative to the gravity direction. That is, the mobile object posture may be determined based on which directions the top-bottom direction, the left-right direction, and the front-rear direction of the mobile object are oriented toward relative to the gravity direction. The predetermined state may be a stopped state of the mobile object. The speed change cycle may refer to, for example, one cycle of speed change of the mobile object from when the mobile object starts from the stopped state to when the mobile object stops. The mobile object posture at the start and end of the speed change cycle may be either an upright state or a leaning state. The speed of the mobile object at the start and end of the speed change cycle may be zero or may be nonzero. It should be noted that the time-series-traveling data for the speed change cycle may be a part or a whole of the time-series-traveling data acquired in one travel period from the start to the end of travel, as long as the part or the whole includes the period from when the mobile object posture and the mobile object speed in the front-rear direction change from the predetermined state to when the mobile object posture and the mobile object speed in the front-rear direction return to the predetermined state. That is, the one travel period may include one or more speed change cycles.

[Speed Change Cycle in Case where Mobile Object is Leaning Vehicle]

In a case where the mobile object is a leaning vehicle herein, a start period, an end period, and one or more acceleration/deceleration periods between the start period and the end period of the speed change cycle may include a left or right turn at an intersection, cornering on a curve, and other motions, or may be free of them. The speed change cycle may include a stopped state or an extremely-low-speed state. The predetermined state may be a stopped state where the posture of the leaning vehicle is upright relative to the ground. The speed change cycle may be, for example, one cycle of speed change of the leaning vehicle in a period from the stopped state where the posture of the leaning vehicle is upright relative to the ground to when the leaning vehicle finally returns to the stopped state where the posture of the leaning vehicle is upright relative to the ground. The stopped state of the leaning vehicle includes not only the upright state of the leaning vehicle, but also a parked state where the leaning vehicle is parked by a center stand or a side stand and a leaning state where a driver places one foot on the ground while waiting at a traffic signal, for example.

### [Convert Time-Series-Traveling Data for at Least Speed Change Cycle in Coordinate System of Sensor to Time-Series-Traveling Data for at Least Speed Change Cycle in Coordinate System of Mobile Object]

The expression “to convert time-series-traveling data for at least a speed change cycle in a coordinate system of a sensor to time-series-traveling data for at least a speed change cycle in a coordinate system of a mobile object” herein means that the three coordinate axes in the coordinate system of the sensor are made parallel to or coincident with the three coordinate axes in the coordinate system of the mobile object, and that time-series-traveling data for at least a speed change cycle in the coordinate system of the sensor is converted to time-series-traveling data for at least a speed change cycle in the coordinate system of the mobile object such that the front-rear direction, the top-bottom direction, and the left-right direction relative to the sensor are aligned with the front-rear direction, the top-bottom direction, and the left-right direction relative to the mobile object.

### Advantageous Effects of Invention

One embodiment of the present teaching can provide a traveling-data-output device, a traveling-data-measuring device, a traveling-data-measuring-and-output device, and a leaning-vehicle-data-processing device capable of acquiring highly accurate traveling data independently of an action of an installer who mounts a detection device on a mobile object.

### BRIEF DESCRIPTION OF DRAWINGS

FIG. 1 is a view illustrating a schematic configuration of a traveling-data-output device according to a first embodiment of the present teaching.

FIG. 2 is a block diagram illustrating a schematic configuration of a traveling-data-output processor included in the traveling-data-output device shown in FIG. 1.

FIG. 3 is a view for explaining a principle by which a coordinate-conversion-data generator shown in FIG. 2 makes three coordinate axes in a coordinate system of a sensor parallel to three coordinate axes in a coordinate system of a leaning vehicle, respectively, based on an acceleration.

FIG. 4 is a view for describing a principle by which the coordinate-conversion-data generator shown in FIG. 2 aligns a front-rear direction, a top-bottom direction, and a left-right direction relative to the sensor with a front-rear direction, a top-bottom direction, and a left-right direction relative to the leaning vehicle, based on an angular velocity about a yaw axis and an angular velocity about a roll axis.

FIG. 5 is a functional block diagram showing a schematic configuration of a coordinate-conversion-data generator included in a traveling-data-output device according to a second embodiment of the present teaching.

FIG. 6 shows views for explaining a principle by which the coordinate-conversion-data generator shown in FIG. 5 determines front and rear based on geomagnetism, wherein (a) is a view showing a bearing by a GPS, and (b) is a view showing a bearing by geomagnetism.

FIG. 7 shows views for explaining a principle by which the coordinate-conversion-data generator shown in FIG. 5 determines front and rear based on a relationship between an acceleration obtained from a GPS velocity and a direction of an X-axis acceleration, wherein (a) shows a case where the front and the rear are matched, and (b) shows a case where the front and the rear are mismatched.

### DESCRIPTION OF EMBODIMENTS

Embodiments will be described hereinafter with reference to the drawings. The dimensions of components in the drawings do not strictly represent actual dimensions of the components and dimensional proportions of the components.

### First Embodiment

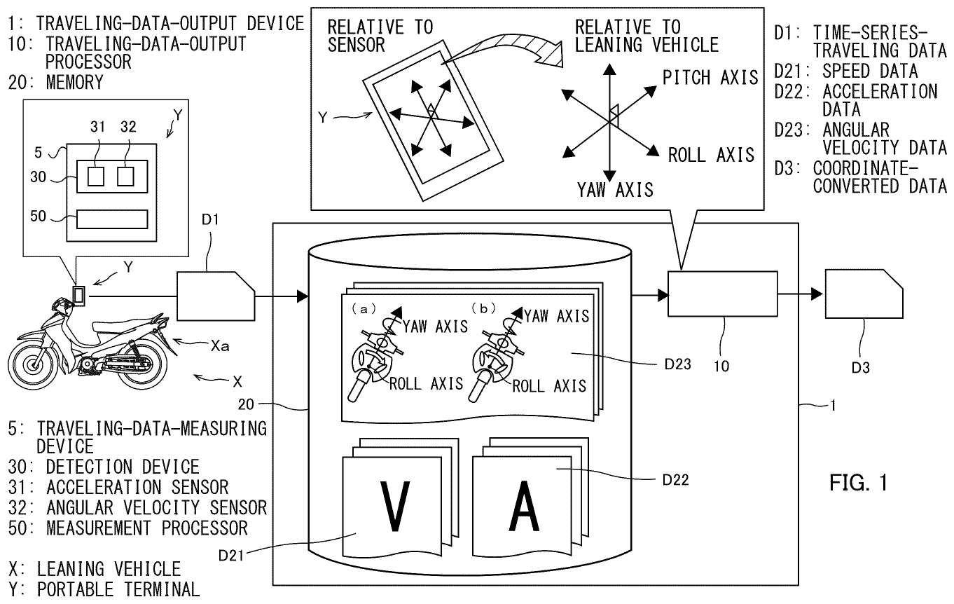

A traveling-data-output device according to a first embodiment of the present teaching will be described with reference to FIGS. 1 through 4.

### (Traveling-Data-Measuring Device)

A traveling-data-measuring device 5 is configured to be mountable on a leaning vehicle X as a mobile object and measure time-series-traveling data for at least the speed change cycle used in coordinate system conversion in a traveling-data-output device 1 described later. The traveling-data-measuring device 5 can be implemented as a portable terminal Y, for example.

The traveling-data-measuring device 5 includes a detection device 30 and a measurement processor 50.

The detection device 30 is incorporated in the portable terminal Y mounted on the leaning vehicle X in a mounting posture according to a free will of an installer, rather than in a mounting posture instructed in advance. The detection device 30 includes a sensor capable of detecting a speed of the leaning vehicle X, accelerations in three axial directions of the front-rear direction, the top-bottom direction, and the left-right direction relative to the detection device 30, and angular velocities about three axes (roll axis, yaw axis, and pitch axis).

The detection device 30 includes, for example, an inertial measurement unit (IMU) including an acceleration sensor 31 and an angular velocity sensor 32. The detection device 30 may be any sensor other than the IMU as long as the sensor can detect at least the speed of the leaning vehicle X, the accelerations in the three coordinate axial directions in the coordinate system of the detection device 30, and the angular velocities about the three coordinate axes in the coordinate system of the detection device 30. The detection device 30 may be a combination of the IMU and another sensor.

The detection device 30 includes a global positioning system (GPS) mounted on the portable terminal Y. The detection device 30 is a sensor capable of outputting the speed of the leaning vehicle X based on positioning data of the GPS. The detection device 30 may include a speed sensor capable of outputting a speed independently of the positioning data of the GPS. The detection device 30 may be a combination of a GPS sensor and another sensor. The detection device 30 may be a combination of the speed sensor and another sensor.

The detection device 30 may be a combination of a sensor capable of detecting one or more types of physical quantities among the speed of the leaning vehicle X, the accelerations in the three coordinate axial directions, and the angular velocities about the three coordinate axes, and one or more sensors capable of detecting the remaining types of physical quantities. The detection device 30 may be capable of detecting at least one of the jerks in the three axial directions, the angles about the three axes, or the angular accelerations about the three axes.

The portable terminal Y as the traveling-data-measuring device 5 is attached to a handlebar of the leaning vehicle X. An installer who attaches the portable terminal Y to the leaning vehicle X may be, but not limited to, a driver of the leaning vehicle X or a technician who performs maintenance of the leaning vehicle X.

In the manner described above, the detection device 30 incorporated in the portable terminal Y attached to the handlebar of the leaning vehicle X detects data on physical quantities related to a behavior of the leaning vehicle X in the coordinate system relative to the detection device 30 and outputs the detected data as traveling data. That is, the detection data detected by the detection device 30 is data in the coordinate system relative to the detection device 30, rather than data in the coordinate system relative to the leaning vehicle X.

The traveling data output from the detection device 30 includes physical quantities such as the speeds in the three axial directions of the front-rear direction, the top-bottom direction, and the left-right direction in the coordinate system of the detection device 30, the angular accelerations and jerks in the three coordinate axial directions in the coordinate system of the detection device 30, and the angles, the angular velocities, and angular accelerations about the three coordinate axes (roll axis, yaw axis, and pitch axis) in the coordinate system of the detection device 30. The detection device 30 outputs the traveling data to the traveling-data-output device 1 in a time-series manner.

Here, one cycle of speed change of the leaning vehicle X in a period in which the leaning vehicle X accelerates and decelerates one or more times from a predetermined state where the leaning vehicle X stands upright relative to the ground (mobile object posture) and the speed (mobile object speed) in the front-rear direction is zero and then the leaning vehicle X finally reaches the predetermined state where the leaning vehicle X stands upright relative to the ground and the speed in the front-rear direction is zero, is defined as a speed change cycle.

The detection device 30 outputs traveling data for at least the speed change cycle to the traveling-data-output device 1 in a time-series manner. The traveling data output from the detection device 30 in a time-series manner will be hereinafter referred to as “time-series-traveling data.”

As described above, the traveling-data-measuring device 5 is mounted on the leaning vehicle X as a mobile object in a mounting posture according to the free will of an installer, rather than in the mounting posture instructed in advance by the installer. In the state where the traveling-data-measuring device 5 is mounted as described above, while the leaning vehicle X is traveling not in the mobile object posture at the mobile object speed instructed in advance but in the mobile object posture at the mobile object speed according to the free will of the installer, the detection device 30 acquires time-series-traveling data D1 including time-series speed data of the leaning vehicle X as a mobile object, acceleration data in the three coordinate axial directions in the coordinate system of the acceleration sensor 31 output from the detection device 30 in a time-series manner, and angular velocity data about the three coordinate axes in the coordinate system of the angular velocity sensor 32.

The measurement processor 50 outputs the time-series-traveling data D1 to the traveling-data-output device 1. Here, the time-series-traveling data D1 includes data for at least a speed change cycle in which, during traveling in the mobile object posture at the mobile object speed according to the free will of the installer, rather than in the mobile object posture at the mobile object speed instructed in advance, the mobile object posture and the mobile object speed in the front-rear direction change from the predetermined state and then return to the predetermined state, in the acquired time-series-traveling data D1. The measurement processor 50 outputs the time-series-traveling data D1 in a format in which the coordinate systems of the acceleration sensor 31 and the angular velocity sensor 32 are allowed to be subjected to coordinate system conversion by a traveling-data-output processor 10 of the traveling-data-output device 1 described later, rather than in a format in which the time-series-traveling data D1 is subjected to coordinate system conversion to convert the coordinate systems of the acceleration sensor 31 and the angular velocity sensor 32 to the coordinate system of the leaning vehicle X as a mobile object.

In the configuration described above, the time-series-traveling data D1 can be output in the format that enables coordinate system conversion by the traveling-data-output processor 10 of the traveling-data-output device 1. Accordingly, the traveling-data-measuring device 5 is capable of outputting time-series-traveling data suitable for a coordinate-system-conversion process of the traveling-data-output device 1.

### (Traveling-Data-Output Device)

FIG. 1 is a view illustrating a schematic configuration of the traveling-data-output device 1 according to the first embodiment of the present teaching. The traveling-data-output device 1 is a device that outputs traveling data of a coordinate system of the leaning vehicle X, based on an output of the detection device 30 that is mounted to be fixed to the leaning vehicle X as a mobile object by an installer and detects a physical quantity related to a behavior of the leaning vehicle X.

The traveling-data-output device 1 includes a traveling-data-output processor 10 and a memory 20.

The memory 20 may be a memory capable of temporarily storing data or may be a nonvolatile readable/writable storage medium such as a flash memory or a hard disk. The memory 20 may have any configuration as long as the memory 20 can temporarily or permanently store data acquired or computed by the traveling-data-output processor 10.

The memory 20 stores time-series-traveling data D1 for at least a speed change cycle output from the detection device 30 incorporated in a portable terminal Y attached to a handlebar of the leaning vehicle X.

In FIG. 1, the time-series-traveling data D1 stored in the memory 20 includes speed data D21, acceleration data D22, and angular velocity data D23 of the leaning vehicle X.

The speed data D21 is speed data related to the speed of the leaning vehicle X during traveling. The speed data D21 includes a speed calculated based on a change in position detected by a GPS mounted on the portable terminal Y.

The acceleration data D22 includes data related to accelerations in three coordinate axial directions in a coordinate system of the acceleration sensor 31 detected by the acceleration sensor 31 of the detection device 30 during traveling of the leaning vehicle X.

The angular velocity data D23 includes data on an angular velocity in leaning a vehicle body Xa leftward or rightward from an upright state or in raising the vehicle body Xa from the state where the vehicle body Xa is leaning leftward or rightward, during traveling of the leaning vehicle X. The angular velocity data D23 also includes data on angular velocities in three coordinate axial directions in a coordinate system of the angular velocity sensor 32 detected by the angular velocity sensor 32 of the detection device 30 during traveling of the leaning vehicle X.

The memory 20 is not limited to the above-described example, and may store data other than the speed data D21, the acceleration data D22, and the angular velocity data D23.

The traveling-data-output processor 10 is a central processing unit for use in, for example, a computer. Although not particularly shown, the traveling-data-output processor 10 acquires time-series-traveling data D1 for at least a speed change cycle output from the detection device 30 of the traveling-data-measuring device 5, and stores the acquired time-series-traveling data D1 in the memory 20. The traveling-data-output processor 10 acquires the time-series-traveling data D1 for at least the speed change cycle and then performs a computation process using the time-series-traveling data D1 stored in the memory 20 to thereby convert the time-series-traveling data D1 for at least the speed change cycle in the coordinate system of the detection device 30 to time-series-traveling data for at least the speed change cycle in a coordinate system of the leaning vehicle X and output the converted time-series-traveling data. The traveling-data-output processor 10 outputs the converted time-series-traveling data as coordinate-converted data D3 to the outside.

In the manner described above, the traveling-data-output device 1 converts the time-series-traveling data D1 for at least the speed change cycle in the coordinate system of the detection device 30 including the acceleration sensor 31 and the angular velocity sensor 32 to time-series-traveling data for at least the speed change cycle in the coordinate system of the leaning vehicle X, and outputs the converted time-series-traveling data.

The traveling-data-measuring device 5 may be implemented by the portable terminal Y, and the traveling-data-output device 1 may be implemented by a server device capable of communicating with the portable terminal Y. For example, the traveling-data-measuring device 5 may include a communication device 55 capable of communicating with the outside. For example, the traveling-data-output device 1 may also acquire data output from the detection device 30 mounted on the portable terminal Y as the traveling-data-measuring device 5, through a communication device configured to communicate with the outside.

That is, the traveling-data-output processor 10 has the function of acquiring the time-series-traveling data D1 for at least the speed change cycle output from the detection device 30, for example. The traveling-data-output processor 10 is a processing device different from the measurement processor 50. As described above, the data output from the measurement processor 50 to the traveling-data-output processor 10 is data based on coordinate systems of the acceleration sensor 31 and the angular velocity sensor 32. That is, the data output from the measurement processor 50 is data before coordinate system conversion to the coordinate system of the mobile object, and is output in a format that enables coordinate system conversion by the traveling-data-output processor 10.

The traveling-data-output processor 10 performs coordinate system conversion on the acquired time-series-traveling data for at least the speed change cycle by using both the time-series-traveling data when the mobile object posture and the mobile object speed in the front-rear direction change from a predetermined state and the time-series-traveling data when the mobile object posture and the mobile object speed in the front-rear direction return to the predetermined state in the acquired time-series-traveling data for at least the speed change cycle, to convert the coordinate systems of the acceleration sensor and the angular velocity sensor to the coordinate system of the mobile object, and outputs the time-series-traveling data for at least the speed change cycle in the converted coordinate system. The traveling-data-output processor 10 performs the process of the coordinate system conversion in the following manner. The traveling-data-output processor 10 makes the three coordinate axes in the coordinate systems of the acceleration sensor 31 and the angular velocity sensor 32 parallel to or coincident with the three coordinate axes in the coordinate system of the leaning vehicle X as a mobile object. Further, the traveling-data-output processor 10 aligns the front-rear direction, the top-bottom direction, and the left-right direction relative to the acceleration sensor 31 and the angular velocity sensor 32 with the front-rear direction, the top-bottom direction, and the left-right direction relative to the leaning vehicle X as a mobile object, respectively.

Accordingly, the traveling-data-output processor 10 performs coordinate system conversion based on the time-series-traveling data D1 for at least the speed change cycle acquired by the detection device 30 mounted in a mounting posture according to the free will of the installer during traveling in the mobile object posture at the mobile object speed according to the free will of the installer, unlike data acquired by the detection device mounted in the mounting posture instructed in advance and data acquired by the detection device before start of traveling in the mobile object posture instructed in advance.

The configuration described above can provide the traveling-data-measuring device 5 for supplying the time-series-traveling data D1 to the traveling-data-output device 1 that performs a coordinate conversion process. In addition, the traveling-data-output device 1 that performs a coordinate conversion process based on the time-series-traveling data D1 supplied from the traveling-data-measuring device 5 is also obtained. Accordingly, the traveling-data-measuring device and the traveling-data-output device can be implemented by different devices. Thus, the present teaching can be achieved by different devices.

In converting the time-series-traveling data D1 of the detection device 30 and outputting the coordinate-converted data D3, the traveling-data-output device 1 according to this embodiment uses the speed data D21 of the leaning vehicle X, the acceleration data D22 in the three coordinate axial directions in the coordinate system of the detection device 30, and the angular velocity data D23 about the three coordinate axes in the coordinate system of the detection device 30 that are included in the time-series-traveling data D1.

In this embodiment, the coordinate-converted data D3 is data obtained by coordinate conversion of the time-series-traveling data D1 output from the detection device 30. Specifically, the traveling-data-output processor 10 makes the three coordinate axes in the coordinate system of the detection device 30 parallel to or coincident with the three coordinate axes in the coordinate system of the leaning vehicle X in accordance with the time-series-traveling data D1, and aligns the front-rear direction, the top-bottom direction, and the left-right direction relative to the detection device 30 with the front-rear direction, the top-bottom direction, and the left-right direction relative to the leaning vehicle X, thereby generating the coordinate-converted data D3 whose coordinates have been converted, from the time-series-traveling data D1. The process of the traveling-data-output processor 10 will be specifically described later.

The coordinate-converted data D3 is used for, for example, generating processed data that can be used for data related to insurance, education, markets, products, services, environments, or customers and other types of data.

In the configuration described above, it is unnecessary to attach the portable terminal

Y to the leaning vehicle X in a fixed posture.

### (Details of Traveling-Data-Output Processor)

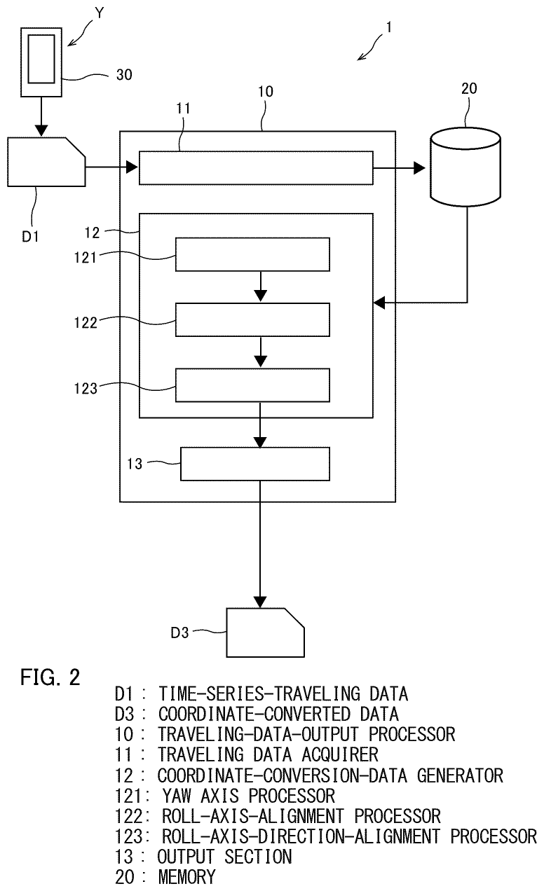

FIG. 2 is a block diagram illustrating a schematic configuration of the traveling-data-output processor 10. As illustrated in FIG. 2, the traveling-data-output processor 10 includes a traveling data acquirer 11, a coordinate-conversion-data generator 12, and an output section 13.

The traveling data acquirer 11 acquires the time-series-traveling data D1 output from the detection device 30 attached to the leaning vehicle X, and stores the acquired time-series-traveling data D1 in the memory 20. The traveling data acquirer 11 acquires the speed data D21, the acceleration data D22, and the angular velocity data D23 of the leaning vehicle X included in the time-series-traveling data D1, and stores the acquired data in the memory 20.

The traveling data acquirer 11 may acquire data other than the speed data D21, the acceleration data D22, and the angular velocity data D23 included in the time-series-traveling data D1. The traveling data acquirer 11 may acquire a physical quantity related to a behavior of the leaning vehicle X other than the speed data D21, the acceleration data D22, and the angular velocity data D23 from the detection device 30 as the time-series-traveling data D1, and store the acquired data in the memory 20. Specifically, the traveling data acquirer 11 may acquire, from the detection device 30, at least one type of physical quantity among jerks in the three axial directions, angles about the three axes or angular accelerations about the three axes from the time-series-traveling data D1 and store the acquired physical quantity in the memory 20.

The coordinate-conversion-data generator 12 generates the coordinate-converted data D3 in which the time-series-traveling data D1 for at least the speed change cycle in the coordinate system of the detection device 30 is converted to the time-series-traveling data for at least the speed change cycle in the coordinate system of the leaning vehicle X such that the three coordinate axes in the time-series-traveling data D1 for at least the speed change cycle in the coordinate system of the detection device 30 stored in the memory 20 are made parallel to or coincident with the three coordinate axes in the coordinate system of the leaning vehicle X and that the front-rear direction, the top-bottom direction, and the left-right direction of the three coordinate axes relative to the detection device 30 are aligned with the directions of the three coordinate axes relative to the leaning vehicle X.

A specific example of a coordinate-converted-data-generating process by the coordinate-conversion-data generator 12 will now be described. In the following specific example, it is assumed that the time-series-traveling data D1 for the speed change cycle includes a turning scene and a straight scene. The coordinate-conversion-data generator 12 separates the turning scene and the straight scene included in the time-series-traveling data D1 in an axial-alignment-and-direction-alignment process for each axis in the coordinate-converted-data-generating process. The coordinate-conversion-data generator 12 performs the axial-alignment-and-direction-alignment process on at least one of the turning scene or the straight scene in accordance with the content of the axial-alignment-and-direction-alignment process for each axis.

### (Coordinate-Converted-Data-Generating Process)

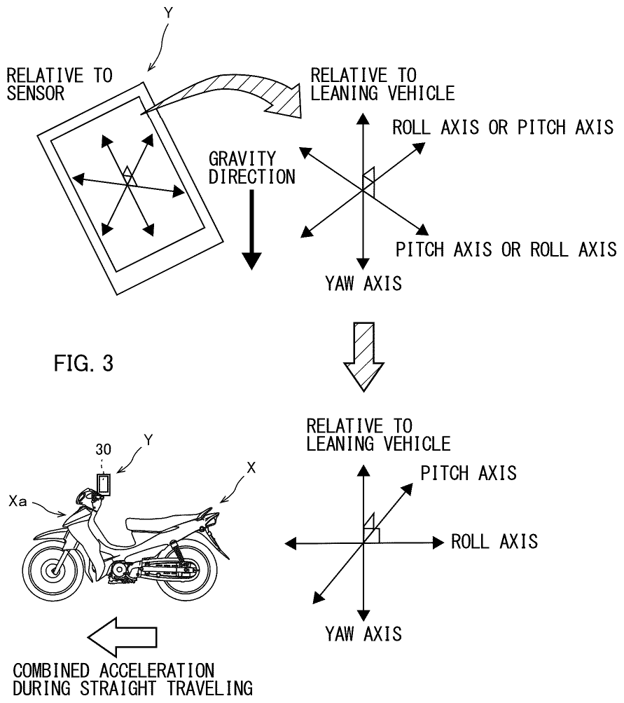

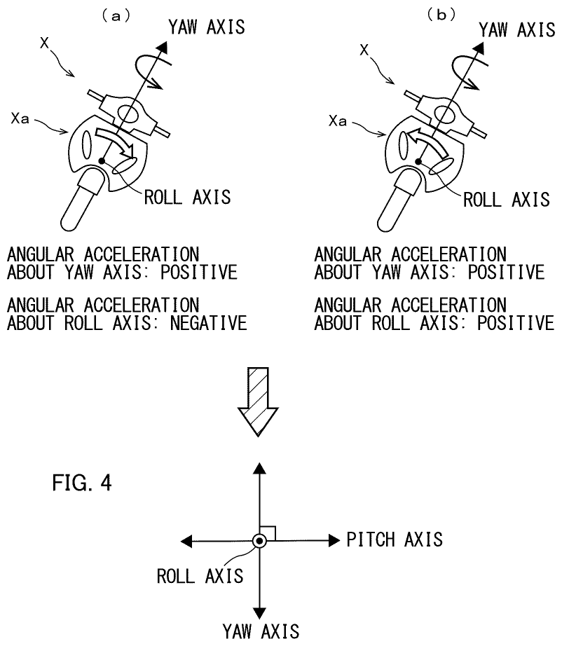

FIGS. 3 and 4 are views for explaining a principle by which, based on the speed, the angular velocity, and the acceleration, the coordinate-conversion-data generator 12 makes the three coordinate axes in the coordinate system of the detection device 30 parallel to the three coordinate axes in the coordinate system of the leaning vehicle X, respectively, and aligns the front-rear direction, the top-bottom direction, and the left-right direction relative to the detection device 30 with the front-rear direction, the top-bottom direction, and the left-right direction relative to the leaning vehicle X.

The coordinate-conversion-data generator 12 included in the traveling-data-output processor 10 makes a sensor-coordinate-system-first axis that is one of the three coordinate axes in the coordinate system of the detection device 30 parallel to or coincident with a leaning-vehicle-coordinate-system-first axis (mobile-object-coordinate-system-first axis) that is one of the three coordinate axes in the coordinate system of the leaning vehicle X, and aligns a direction of the sensor-coordinate-system-first axis with a direction of the leaning-vehicle-coordinate-system-first axis in a state where the sensor-coordinate-system-first axis is made parallel to or coincident with the leaning-vehicle-coordinate-system-first axis.

Accordingly, flexibility of axial alignment and direction alignment in the conversion processing of the time-series-traveling data can be reduced, and thus, conversion processing of the time-series-traveling data can be easily performed.

In another aspect, the coordinate-conversion-data generator 12 included in the traveling-data-output processor 10 makes remaining coordinate axes other than the sensor-coordinate-system-first axis in the three coordinate axes in the coordinate system of the detection device 30 parallel to or coincident with remaining coordinate axes other than the leaning-vehicle-coordinate-system-first axis in the three coordinate axes in the coordinate system of the leaning vehicle X, and aligns a direction relative to the directions of the remaining coordinate axes other than the sensor-coordinate-system-first axis with the directions of the remaining coordinate axes other than the leaning-vehicle-coordinate-system-first axis, in a state where the sensor-coordinate-system-first axis is made parallel to or coincident with the leaning-vehicle-coordinate-system-first axis and the direction of the sensor-coordinate-system-first axis is aligned with the direction of the leaning-vehicle-coordinate-system-first axis.

In the configuration described above, among the three coordinate axes in the sensor coordinate system to be processed, the sensor-coordinate-system-first axis and the direction thereof are determined relative to the leaning-vehicle-coordinate-system-first axis, and thus, flexibility in the conversion process can be reduced accordingly. This makes the conversion process of the remaining coordinate axes easier.

The leaning-vehicle-coordinate-system-first axis is a top-bottom axis (yaw axis) extending in the top-bottom direction in the coordinate system of the leaning vehicle X. In the configuration described above, the top-bottom axis in the coordinate system of the leaning vehicle X corresponds to the gravity direction. Thus, the use of time-series-traveling data for a speed change cycle eases alignment of the sensor coordinate system with the gravity direction of the leaning vehicle X.

A specific configuration of the coordinate-conversion-data generator 12 will be described hereinafter also with reference to FIG. 2. The coordinate-conversion-data generator 12 includes a yaw axis processor 121, a roll-axis-alignment processor 122, and a roll-axis-direction-alignment processor 123. A coordinate-converted-data-generating process in the coordinate-conversion-data generator 12 is not particularly limited, and can be achieved when, for example, components of the coordinate-conversion-data generator 12 perform processes as follows:

### (Axial-Alignment-and-Direction-Alignment Process of Yaw Axis)

The yaw axis processor 121 makes a sensor-coordinate-system-yaw axis (sensor-coordinate-system-first axis) that is one of the three coordinate axes in the coordinate system of the detection device 30 parallel to or coincident with a leaning-vehicle-coordinate-system-yaw axis (leaning-vehicle-coordinate-system-first axis) that is one of the three coordinate axes in the coordinate system of the leaning vehicle X.

Here, as the coordinate system of the detection device 30 and the coordinate system of the leaning vehicle X, for example, coordinate systems having the respective centers of gravity as the origins can be employed.

The expression “making the coordinate axes in the sensor coordinate system parallel to the coordinate axes in the leaning vehicle coordinate system” includes, for example, setting the coordinate axes in the coordinate system of the detection device 30 in the state of being parallel to the coordinate axes in the coordinate system of the leaning vehicle X by performing a rotation process about the origin on the coordinate axes in the coordinate system of the detection device 30 in a case where the origin of the coordinate system of the detection device 30 is offset from the origin of the coordinate system of the leaning vehicle X.

The expression “making the coordinate axes in the coordinate system of the detection device 30 coincident with the coordinate axes in the coordinate system of the leaning vehicle X” includes, for example, making the coordinate axes in the coordinate system of the detection device 30 coincident with the coordinate axes in the coordinate system of the leaning vehicle X by performing a rotation process about the origin in a case where the origin of the coordinate system of the detection device 30 and the origin of the coordinate system of the leaning vehicle X coincide with each other.

The yaw axis processor 121 specifies the roll axis of the leaning vehicle X based on the acceleration data, for example.

Specifically, first, the yaw axis processor 121 calculates an average of the acceleration data and obtains a gravitational acceleration. Then, as illustrated in FIG. 3, the yaw axis processor 121 specifies a yaw axis relative to the leaning vehicle X, based on a gravity direction obtained from the gravitational acceleration.

Specifically, first, the yaw axis processor 121 calculates an average of accelerations included in the time-series-traveling data D1 for at least the speed change cycle to thereby obtain a gravitational acceleration. Accordingly, the gravity direction can be specified. Subsequently, as illustrated in FIG. 3, the yaw axis processor 121 specifies a yaw axis relative to the leaning vehicle X, based on a gravity direction obtained from the gravitational acceleration.

Here, since the gravitational acceleration is detected as a physical quantity exerted on the downward direction in the top-bottom direction in the coordinate system of the leaning vehicle X, the yaw axis processor 121 can also align the positive and negative directions of the axis, with the sensor-coordinate-system-yaw axis made parallel to or coincident with the leaning-vehicle-coordinate-system-yaw axis.

In the manner described above, the yaw axis processor 121 aligns the direction of the leaning-vehicle-coordinate-system-yaw axis with the direction of the gravity direction, with the sensor-coordinate-system-yaw axis made parallel to or coincident with the specified gravity direction, that is, the leaning-vehicle-coordinate-system-yaw axis.

### (Axial Alignment Process of Roll Axis)

As illustrated in FIG. 3, the roll-axis-alignment processor 122 aligns the sensor-coordinate-system-roll axis and the sensor-coordinate-system-pitch axis that are orthogonal to each other in the sensor coordinate system, by using the sensor-coordinate-system-yaw axis subjected to axial alignment and direction alignment and an acceleration component (see white arrow in FIG. 3) during straight traveling in the acceleration data. That is, the roll-axis-alignment processor 122 calculates a combined acceleration vector by combining accelerations included in the time-series-traveling data D1 for at least the speed change cycle, and makes a sensor-coordinate-system-second axis parallel to or coincident with the calculated combined acceleration vector.

Specifically, the roll-axis-alignment processor 122 determines that the leaning vehicle X is traveling straight in a case where a change in position detected by the GPS is larger than a predetermined speed and a combined angular velocity obtained from the angular velocity data is less than a predetermined angular velocity, for example.

The predetermined speed is a lower limit value of the speed in a case where the leaning vehicle X is determined to be traveling straight. The predetermined angular velocity is an upper limit value of the angular velocity in the case where the leaning vehicle X is determined to be traveling straight.

The roll-axis-alignment processor 122 calculates a combined acceleration vector by combining accelerations in a section where the leaning vehicle X is determined to be traveling straight in the acceleration data. The roll-axis-alignment processor 122 makes the sensor-coordinate-system-roll axis (sensor-coordinate-system-second axis) parallel to or coincident with the calculated combined acceleration vector.

In this manner, the sensor-coordinate-system-roll axis can be aligned with a leaning-vehicle-coordinate-system-roll axis. In another aspect, at this time, the sensor-coordinate-system-pitch axis is orthogonal to the leaning-vehicle-coordinate-system-roll axis and aligned with the leaning-vehicle-coordinate-system-pitch axis.

### (Direction Alignment Process of Roll Axis)

The roll-axis-direction-alignment processor 123 aligns the direction of the roll axis (sensor-coordinate-system-second axis) in the coordinate system of the detection device 30 with the direction of the front-rear axis in the coordinate system of the leaning vehicle X. The principle of a direction alignment process of the roll axis by the roll-axis-direction-alignment processor 123 is as follows:

The leaning vehicle X has a characteristic of leaning leftward when turning to the left and leaning rightward when turning to the right. As illustrated in FIG. 4(a), in leaning the vehicle body Xa of the leaning vehicle X leftward or rightward from an upright state before turning to the left, for example, the angular velocity about the yaw axis (indicated by solid arrows in FIG. 4) and the angular velocity about the roll axis (indicated by white arrows in FIG. 4) have different signs (i.e., positive and negative signs are opposite to each other). As also illustrated in FIG. 4(b), in raising the vehicle body Xa of the leaning vehicle X from the state of leaning leftward or rightward after turning, the angular velocity about the yaw axis and the angular velocity about the roll axis have the same sign (i.e., positive and negative signs are the same). The inventors of the present teaching have focused on the fact that the leaning vehicle X has such a characteristic during turning, and have conceived of specifying the direction of the roll axis by using the angular velocity about the yaw axis and the angular velocity about the roll axis.

That is, the inventors of the present teaching found that the front-rear direction of the roll axis can be determined by setting the roll axis in traveling data of the detection device 30 before and after turning of the leaning vehicle X such that in leaning the vehicle body Xa leftward or rightward from the upright state before turning, the angular velocity about the yaw axis and the angular velocity about the roll axis have different signs, or in raising the vehicle body Xa from the state of leaning leftward or rightward after turning, the angular velocity about the yaw axis and the angular velocity about the roll axis have the same sign.

From the foregoing aspects, in the turning scene, the roll-axis-direction-alignment processor 123 according to this embodiment aligns the direction relative to the detection device 30 with the direction relative to the leaning vehicle X based on the angular velocity detected during turning of the leaning vehicle X. That is, during traveling of the leaning vehicle X, the roll-axis-direction-alignment processor 123 specifies the front-rear direction of the roll axis based on angular velocity data on the angular velocity in leaning the vehicle body Xa leftward or rightward from the upright state or in raising the vehicle body Xa from the leftward or rightward leaning state.

For example, the roll-axis-direction-alignment processor 123 specifies the front-rear direction of the roll axis based on the angular velocity data in the following manner. If the product of the angular velocity about the yaw axis and the angular velocity about the roll axis is negative in leaning the vehicle body Xa leftward or rightward from the upright state during traveling of the leaning vehicle X as illustrated in FIG. 4(a), or if the product of the angular velocity about the yaw axis and the angular velocity about the roll axis is positive in raising the vehicle body Xa from the leftward or rightward leaning state during traveling of the leaning vehicle X as illustrated in FIG. 4(b), the roll-axis-direction-alignment processor 123 determines that the direction of the roll axis at the leaning or raising is correct (the bottom view in FIG. 4). If the product of the angular velocity about the yaw axis and the angular velocity about the roll axis is positive in leaning the vehicle body Xa leftward or rightward from the upright state during traveling of the leaning vehicle X or if the product of the angular velocity about the yaw axis and the angular velocity about the roll axis is negative in raising the vehicle body Xa from the leftward or rightward leaning state during traveling of the leaning vehicle X, the roll-axis-direction-alignment processor 123 determines that the direction of the roll axis at the leaning or raising is reversed.

In the manner described above, in the turning scene, the roll-axis-direction-alignment processor 123 aligns the direction of the roll axis relative to the detection device 30 with the direction of the roll axis relative to the leaning vehicle X based on the angular velocity detected during turning of the leaning vehicle X.

With the configurations of the components of the coordinate-conversion-data generator 12 as described above, the directions of the roll axis, the pitch axis, and the yaw axis in the coordinate system of the leaning vehicle X are specified based on the time-series-traveling data D1 output from the detection device 30.

The coordinate-conversion-data generator 12 generates the coordinate-converted data D3 subjected to coordinate conversion from the time-series-traveling data D1 such that the three coordinate axes in the coordinate system of the detection device 30 are made parallel to the roll axis, the pitch axis, and the yaw axis, respectively, in the coordinate system of the leaning vehicle X specified as described above and that the front-rear direction, the top-bottom direction, and the left-right direction relative to the detection device 30 are aligned with the directions relative to the leaning vehicle X.

The coordinate-conversion-data generator 12 outputs the generated coordinate-converted data D3 to the output section 13. The output section 13 outputs the coordinate-converted data D3 to the outside of the traveling-data-output device 1.

As described above, the traveling-data-output device 1 includes the traveling-data-output processor 10 that outputs traveling data of the coordinate system of the leaning vehicle X based on the output of the detection device 30 mounted on the leaning vehicle X as a mobile object and configured to detect a physical quantity related to a behavior of the leaning vehicle X.

The traveling-data-output processor 10 and the detection device 30 are incorporated in the portable terminal Y attached to the leaning vehicle X. Accordingly, the portable terminal Y attached to the leaning vehicle X can perform a computation process of generating the coordinate-converted data D3 from detection data of the detection device 30.

The detection device 30 is mounted on the leaning vehicle X in the mounting posture according to the free will of the installer, rather than in the mounting posture instructed in advance, and outputs traveling data including the speed of the leaning vehicle X, the accelerations in three coordinate axial directions in the coordinate system of the detection device 30, and the angular velocities about the three coordinate axes in the coordinate system of the detection device 30.

The traveling-data-output processor 10 acquires the time-series-traveling data D1 that is traveling data output in a time-series manner, from the detection device 30 for at least a speed change cycle.

Here, the speed change cycle is one cycle of speed change of the leaning vehicle X in a period in which from a predetermined state where the leaning vehicle X stands upright relative to the ground and the speed in the front-rear direction is zero, the leaning vehicle X accelerates and decelerates one or more times, and then, the leaning vehicle X finally stands upright relative to the ground and reaches the predetermined state where the speed in the front-rear direction is zero.

After the traveling-data-output processor 10 acquires the time-series-traveling data D1 for at least the speed change cycle, the traveling-data-output processor 10 outputs the coordinate-converted data D3 obtained by converting the time-series-traveling data D1 for at least the speed change cycle in the coordinate system of the detection device 30 to time-series-traveling data for at least the speed change cycle in the coordinate system of the leaning vehicle X in accordance with the time-series-traveling data D1 for at least the speed change cycle.

In the conversion by the traveling-data-output processor 10, the following process is performed.

First, the three coordinate axes in the coordinate system of the detection device 30 are made parallel to or coincident with the three coordinate axes in the coordinate system of the leaning vehicle X.

In the state where the coordinate axes are aligned, the front-rear direction, the top-bottom direction, and the left-right direction relative to the detection device 30 are aligned with the front-rear direction, the top-bottom direction, and the left-right direction relative to the leaning vehicle X, for each coordinate axis.

In the configuration described above, the time-series-traveling data D1 for the speed change cycle is acquired such that the gravity acts in the top-bottom direction of the leaning vehicle X at the start and end of the speed change cycle. Thus, by using the speed data D21 and the acceleration data D22 in the three axial directions, the yaw axis (Z axis) can be easily estimated from the time-series-traveling data D1 for the speed change cycle. At the start and end of the speed change cycle, the travelling speed of the leaning vehicle X may be extremely low.

By using the speed data D21 and the angular velocity data D23 about the three axes, for example, in the time-series-traveling data D1 for the speed change cycle, it is possible to easily separate the straight scene and the turning scene.

Since batch processing is performed on a certain amount of data, both accuracy and convenience can be achieved. That is, in acquiring traveling data of the leaning vehicle X, it is unnecessary to assume that the sensor is attached to the leaning vehicle X in the mounting posture instructed in advance and to perform a special operation such as calibration after the attachment.

It is therefore possible to provide the traveling-data-output device 1 that is convenient for the user and can acquire highly accurate coordinate-converted data.

The significance of defining the time-series-traveling data for the speed change cycle as described above is as follows:

In the time-series-traveling data for the speed change cycle, the leaning vehicle X is in the stopped state at the start of the speed change cycle, and at the end of the speed change cycle, the leaning vehicle X is in the stopped state. In the speed change cycle, one or more acceleration/deceleration sections from the start to the end can include various scenes such as the straight scene and the turning scene. The leaning vehicle X leans leftward or rightward when turning.

Unlike four-wheeled vehicles, the leaning vehicle X performs a leaning action during traveling. For example, even when the leaning vehicle X travels in a straight lane, the leaning vehicle X might lean leftward or rightward within the same lane. Thus, for example, the leaning vehicle X may travel toward the right in the lane to make a right turn at an intersection or travel toward the left in the lane to make a left turn at an intersection. In addition, it is also expected that when the leaning vehicle X is traveling in the center of a lane and a manhole or the like is located in the center of the lane, the leaning vehicle X may avoid the manhole or the like by shifting to the left or the right and then return to the center of the lane.

Thus, in the time-series-traveling data for the speed change cycle, the section between the start state and the end state can include the above-mentioned leaning state toward the left or the right during traveling of the leaning vehicle X, but the start state and the end state in the speed change cycle are the same. This enhances accuracy of the axial alignment process and the direction alignment process.

As described above, the leaning-vehicle-coordinate-system-first axis is a top-bottom axis extending in the top-bottom direction in the coordinate system of the leaning vehicle X. Thus, from another viewpoint, the traveling-data-output device 1 can also be expressed as follows:

Specifically, in the state where the sensor-coordinate-system-first axis is made parallel to or coincident with the top-bottom axis in the coordinate system of the leaning vehicle X and the direction of the sensor-coordinate-system-first axis is aligned with the direction of the top-bottom axis in the coordinate system of the leaning vehicle X, the traveling-data-output processor 10 included in the traveling-data-output device 1 makes the sensor-coordinate-system-second axis that is one of the remaining coordinate axes in the coordinate system of the detection device 30 parallel to or coincident with the front-rear axis extending in the front-rear direction in the coordinate system of the leaning vehicle X to thereby align the direction of the sensor-coordinate-system-second axis with the direction of the front-rear axis in the coordinate system of the leaning vehicle X.

In the configuration described above, first, the traveling-data-output processor 10 specifies the top-bottom axis and the direction of the top-bottom axis. The top-bottom axis in the coordinate system of the leaning vehicle X corresponds to the gravity direction. Thus, the use of the time-series-traveling data D1 for the speed change cycle eases alignment of the sensor coordinate system with the top-bottom axis of the leaning vehicle X and also eases alignment of the directions of the coordinate axes relative to the detection device 30 with the directions of the coordinate axes relative to the leaning vehicle X.

After the top-bottom axis of the leaning vehicle X and the direction of the top-bottom axis are specified, it is sufficient to align the remaining left-right axis and front-rear axis. At this time, the use of the time-series-traveling data D1 for the speed change cycle also eases specification of the front-rear axis and the direction of the front-rear axis in the coordinate system of the leaning vehicle X. Accordingly, efficiency and accuracy of the conversion process of the coordinate axes are enhanced, as compared to the case of performing the conversion process relative to the top-bottom axis in the coordinate system of the leaning vehicle X.

The traveling-data-output processor 10 included in the traveling-data-output device 51 performs a conversion process in the order of an axial-alignment-and-direction-alignment process of the yaw axis, an axial alignment process of the roll axis, and a direction alignment process of the roll axis, as follows:

The axial-alignment-and-direction-alignment process of the yaw axis is a process of calculating an average of accelerations included in the time-series-traveling data D1 for at least the speed change cycle to thereby specify a gravity direction, making the sensor-coordinate-system-first axis parallel to or coincident with the specified gravity direction, and aligning the direction of the sensor-coordinate-system-first axis with the gravity direction.

The axial alignment process of the roll axis is a process of calculating a combined acceleration vector as a combination of accelerations included in the time-series-traveling data D1 for at least the speed change cycle, and making the sensor-coordinate-system-second axis parallel to or coincident with the calculated combined acceleration vector.

The direction alignment process of the roll axis is a process of aligning the direction relative to the detection device 30 with the direction relative to the leaning vehicle X based on an angular velocity detected during turning of the leaning vehicle X.

In the configuration described above, with the axial-alignment-and-direction-alignment process of the yaw axis, directions of the coordinate axes in the sensor coordinate system can be aligned with the top-bottom axis of the leaning vehicle X and the direction of the top-bottom axis. With the axial alignment process of the roll axis, the coordinate axis in the sensor coordinate system can be aligned with the front-rear axis of the leaning vehicle X. With the direction alignment process of the roll axis, the direction of the coordinate axis in the sensor coordinate system can be aligned with the direction of the front-rear axis of the leaning vehicle X.

### Second Embodiment

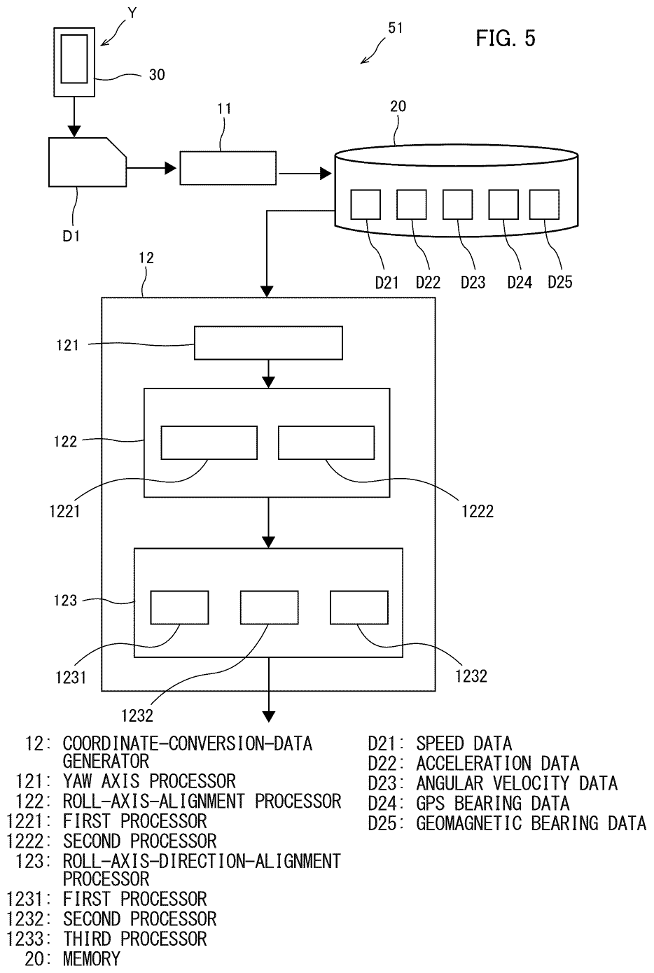

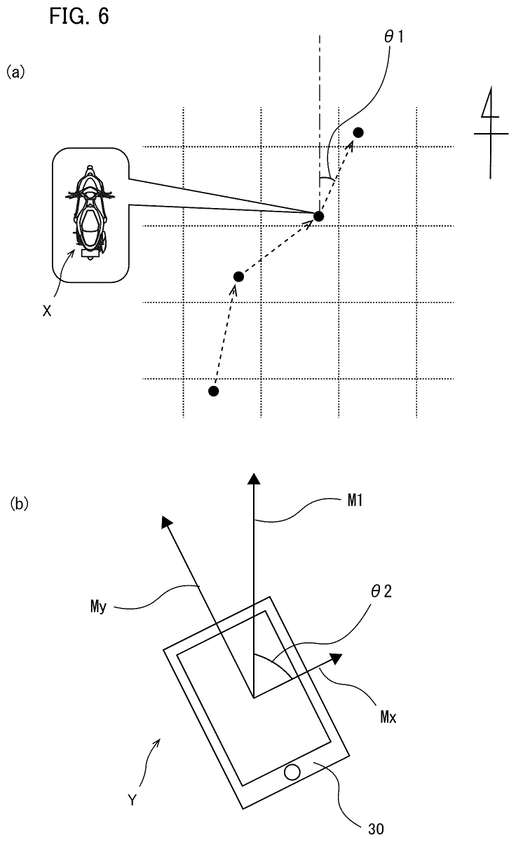

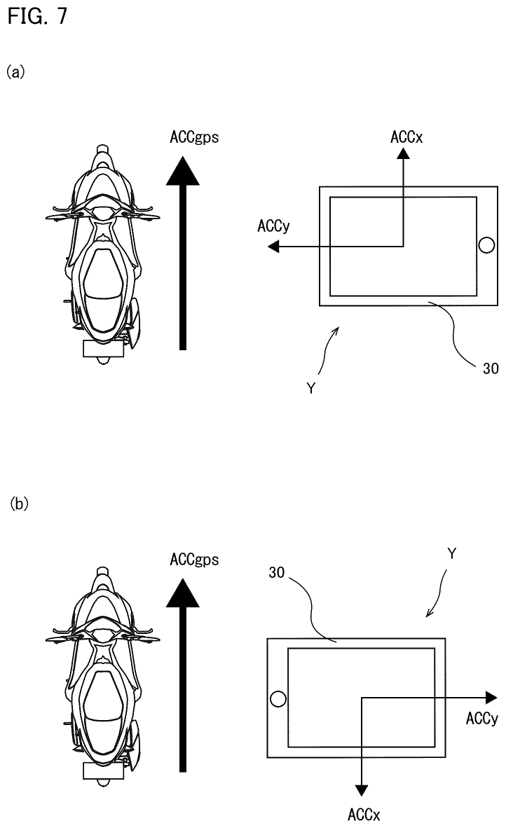

With reference to FIGS. 5 through 7, a traveling-data-output device 51 according to a second embodiment of the present teaching will be described. FIG. 5 is a view illustrating a schematic configuration of a coordinate-conversion-data generator 12 included in the traveling-data-output device 51 according to the second embodiment of the present teaching. FIG. 6 shows views for explaining a principle by which the coordinate-conversion-data generator 12 shown in FIG. 5 determines front and rear based on the geomagnetism, wherein (a) is a view showing a bearing by a GPS, and (b) is a view showing a bearing by the geomagnetism. FIG. 7 shows views for explaining a principle by which the coordinate-conversion-data generator 12 shown in FIG. 5 determines front and rear based on a relationship between an acceleration obtained from a GPS velocity and a direction of an X-axis acceleration, wherein (a) shows a case where the front and the rear are matched, and (b) shows a case where the front and the rear are mismatched.

The traveling-data-output device 51 according to the second embodiment is different from the traveling-data-output device 1 according to the first embodiment in a coordinate-converted-data-generating process in the coordinate-conversion-data generator 12. In description of the second embodiment, detailed description of the same parts as those in the traveling-data-output device 1 of the first embodiment will not be repeated.

As illustrated in FIG. 5, a traveling data acquirer 11 generates GPS bearing data D24 and geomagnetic bearing data D25 when acquiring time-series-traveling data D1 from a detection device 30. The traveling data acquirer 11 stores the generated GPS bearing data D24 and geomagnetic bearing data D25 in a memory 20. That is, the detection device 30 includes a geomagnetic sensor mounted on a portable terminal Y.

Time-series-traveling data stored in the memory 20 further includes the GPS bearing data D24 and the geomagnetic bearing data D25, in addition to the speed data D21, the acceleration data D22, and the angular velocity data D23 of a leaning vehicle X described above.

The GPS bearing data D24 includes data related to a bearing angle θ1 in the traveling direction of the leaning vehicle X that can be acquired based on data output from a GPS mounted on the portable terminal Y. That is, as illustrated in FIG. 6(a), the GPS bearing data D24 includes the bearing angle θ1 calculated based on a change in position detected by the GPS.

The geomagnetic bearing data D25 includes data related to a bearing angle that can be acquired based on data output from a geomagnetic sensor mounted on the portable terminal Y. Specifically, the geomagnetic bearing data D25 is generated by the traveling data acquirer 11 in the following manner. That is, the geomagnetic sensor included in the detection device 30 measures magnetic flux lines in three axial directions. For example, the traveling data acquirer 11 calculates a geomagnetic bearing, which is a horizontal component relative to the ground, among the directions of the three axes of the magnetic flux lines, based on accelerations included in the time-series-traveling data D1. The calculation of the geomagnetic bearing can be performed by a known technique. The thus-obtained geomagnetic bearing is stored in the memory 20 as the geomagnetic bearing data D25. Thus, as illustrated in FIG. 6(b), the geomagnetic bearing data D25 includes a bearing angle θ2 relative to a geomagnetic bearing M1 calculated based on magnetic flux lines detected by the geomagnetic sensor.

### (Axial-Alignment-and-Direction-Alignment Process of Yaw Axis)

The yaw axis processor 121 has the same configuration as that of the first embodiment described above. Therefore, the detailed description will not be repeated here.

### (Axial Alignment Process of Roll Axis)

As illustrated in FIG. 5, a roll-axis-alignment processor 122 includes a first processor 1221 and a second processor 1222.

The first processor 1221 calculates a correction angle for making a sensor-coordinate-system-second axis parallel to or coincident with a combined acceleration vector. The first processor 1221 has the same configuration as that of the roll-axis-alignment processor 122 of the first embodiment described above. Therefore, the detailed description will not be repeated here.

Based on the bearing by the GPS and the bearing by geomagnetism, the second processor 1222 determines a correction angle for making a roll axis (sensor-coordinate-system-second axis) in a coordinate system of the detection device 30 parallel to or coincident with a front-rear axis extending in the front-rear direction in a coordinate system of the leaning vehicle X.

That is, the second processor 1222 determines a correction angle based on the GPS bearing data D24 and the geomagnetic bearing data D25 stored in the memory 20.

As described with reference to FIG. 6, the GPS bearing data D24 includes data related to the bearing angle θ1 of the traveling direction of the leaning vehicle X. The geomagnetic bearing data D25 includes data related to the bearing angle θ2 between the geomagnetic bearing M1 and a sensor-coordinate-system-roll axis Mx. More specifically, for example, on a sensor-coordinate-system-roll axis Mx-sensor-coordinate-system-pitch axis My plane in a state where axial alignment and direction alignment of the yaw axis have been finished, the bearing angle θ2 with respect to the geomagnetic bearing M1 can be expressed as an angle between the geomagnetic bearing M1 and the sensor-coordinate-system-roll axis Mx.

Here, the bearing angle θ1 by the GPS is data unaffected by direction of the portable terminal Y, whereas the bearing angle θ2 by geomagnetism is data affected by the direction of the portable terminal Y. A difference between the bearing by the GPS and the bearing by the geomagnetism expresses a difference in the roll axis of the leaning vehicle X.

In this manner, the second processor 1222 determines a correction angle in accordance with a difference between the bearing by the GPS and the bearing by the geomagnetism.

The roll-axis-alignment processor 122 performs a final axial alignment process of the roll axis based on process results of the correction angles of the first processor 1221 and the second processor 1222.

The final axial alignment process of the roll axis includes a process based on parameters obtained by performing statistics processing on process results of the first processor 1221 and the second processor 1222. For example, the final axial alignment process of the roll axis includes a process based on a parameter obtained by averaging or weighted averaging the process results of the first processor 1221 and the second processor 1222.

In addition, for example, the final axial alignment process of the roll axis includes selecting the process result of one of the first processor 1221 or the second processor 1222.

The roll-axis-alignment processor 122 makes the sensor-coordinate-system-second axis parallel to or coincident with the calculated combined acceleration vector, based on the process results of the correction angles of the first processor 1221 and the second processor 1222.

### (Direction Alignment Process of Roll Axis)

As illustrated in FIG. 5, a roll-axis-direction-alignment processor 123 includes a first processor 1231, a second processor 1232, and a third processor 1233.

The first processor 1231 performs front-rear determination of the aligned roll axis, based on an angular velocity detected during turning of the leaning vehicle X. The first processor 1231 performs a process similar to the direction alignment process of the roll axis described in the first embodiment. Therefore, the detailed description will not be repeated hereinafter.

The second processor 1232 performs front-rear determination of the aligned roll axis based on the accelerations in the three coordinate axial directions included in the time-series-traveling data D1 for at least a speed change cycle and an acceleration calculated from the speed of the leaning vehicle X. More specifically, with reference to FIG. 7, the second processor 1232 acquires a roll-axis acceleration ACCx in a coordinate axis direction of the sensor-coordinate-system-roll axis, from the acceleration data D22 stored in the memory 20. The second processor 1232 acquires a speed included in the speed data D21 stored in the memory 20, and calculates a GPS acceleration ACCgps based on a change of the speed. In a state where the roll axis alignment has been finished, it is assumed that the sensor-coordinate-system-roll axis is parallel to or coincident with the traveling direction of the leaning vehicle X. At this time, the roll-axis acceleration ACCx of the sensor coordinate system and the GPS acceleration ACCgps have a correlation. As illustrated in FIG. 7(a), if the direction of the roll-axis acceleration ACCx of the sensor coordinate system and the direction of the GPS acceleration ACCgps are matched, it is determined that the front and the rear are matched. As illustrated in FIG. 7(b), if the direction of the roll-axis acceleration ACCx of the sensor coordinate system and the direction of the GPS acceleration ACCgps are mismatched, it is determined that the front and the rear are mismatched.

The second processor 1232 may perform the determination process described above if a correlation coefficient is greater than or equal to a predetermined threshold.

The third processor 1233 performs front-rear determination of the aligned roll axis, based on the bearing by the GPS included in the GPS bearing data D24 and the bearing by the geomagnetism included in the geomagnetic bearing data D25. More specifically, the third processor 1233 calculates a difference between the bearing by the GPS and the bearing by the geomagnetism. In addition, for example, if the calculated difference is larger than 180°, the third processor 1233 determines that the front-rear direction is reversed. On the other hand, if the calculated difference is less than or equal to 180°, the third processor 1233 determines that the front-rear direction is correct.

The roll-axis-direction-alignment processor 123 performs a final direction alignment process of the roll axis based on process results of the front-rear determination by the first processor 1231, the second processor 1232, and the third processor 1233.

The final direction alignment process of the roll axis includes a process based on a parameter obtained by statistically processing the process results of the first processor 1231, the second processor 1232, and the third processor 1233. The process results of the first processor 1231, the second processor 1232, and the third processor 1233 may include a true/false value indicating whether the front-rear direction of the roll axis is correct and a score indicating a confidence level of the alignment of the front-rear direction of the roll axis. For example, the final direction alignment process of the roll axis may include a process of comparing a value obtained by averaging or weighted averaging scores included in process results of the first processor 1231, the second processor 1232, and the third processor 1233 with a predetermined threshold.

In addition, for example, the final direction alignment process of the roll axis includes selecting a process result of one of the first processor 1231, the second processor 1232, or the third processor 1233.

Further, for example, the final direction alignment process of the roll axis includes majority-based determination based on true/false values included in the process results of the first processor 1231, the second processor 1232, and the third processor 1233.

The roll-axis-direction-alignment processor 123 aligns the direction relative to the detection device 30 with the direction relative to the leaning vehicle X, based on process results of front-rear determination of the first processor 1231, the second processor 1232, and the third processor 1233.

As described above, the time-series-traveling data D1 further includes the bearing by the GPS as a positioning satellite system and the bearing by the geomagnetism.

As described above, the traveling-data-output processor 10 included in the traveling-data-output device 51 performs a conversion process in the order of the axial-alignment-and-direction-alignment process of the yaw axis, the axial alignment process of the roll axis, and the direction alignment process of the roll axis, as follows:

The axial-alignment-and-direction-alignment process of the yaw axis is a process of calculating an average of accelerations included in the time-series-traveling data D1 for at least the speed change cycle to thereby specify a gravity direction, making the sensor-coordinate-system-first axis parallel to or coincident with the specified gravity direction, and aligning the direction of the sensor-coordinate-system-first axis with the gravity direction.

The axial alignment process of the roll axis is at least one of a process of calculating a combined acceleration vector by combining accelerations included in the time-series-traveling data D1 for at least the speed change cycle and making the sensor-coordinate-system-second axis parallel to or coincident with the calculated combined acceleration vector, or a process of making the sensor-coordinate-system-second axis parallel to or coincident with the front-rear axis extending in the front-rear direction in the coordinate system of the leaning vehicle X, based on the bearing by the GPS and the bearing by the geomagnetism.

The direction alignment process of the roll axis is at least one of a process of aligning the direction relative to the detection device 30 with the direction relative to the leaning vehicle X based on an angular velocity detected during turning of the leaning vehicle X, a process of aligning the direction relative to the detection device 30 with the direction relative to the leaning vehicle X based on accelerations in the three coordinate axial directions included in the time-series-traveling data D1 for at least the speed change cycle and an acceleration calculated from the speed of the leaning vehicle X, or a process of aligning the direction relative to the detection device 30 with the direction relative to the leaning vehicle X based on the bearing by the GPS and the bearing by the geomagnetism for the sensor-coordinate-system-second axis.

This eases the conversion process of the time-series-traveling data D1 and enhances efficiency and accuracy of the conversion process of the coordinate axes.

### Other Embodiments

The embodiments of the present teaching have been described above, but the embodiments are merely examples for carrying out the present teaching. Thus, the present teaching is not limited to the embodiments described above, and the embodiments may be modified as necessary within a range not departing from the gist of the present teaching.

In the above embodiments, the traveling-data-output device 1, 51 is applied to the leaning vehicle X. In other words, the above embodiments are directed to the leaning-vehicle-data-processing device for processing sensor output data in the leaning vehicle whose body leans leftward when turning to the left and leans rightward when turning to the right. The mobile object posture during traveling includes at least the leaning posture related to the left-right direction of the mobile object. In the leaning vehicle, in a case where the vehicle body leans due to an in-lane path change or the like, a leaning behavior in the left direction or in the right direction of the vehicle body of the leaning vehicle appears in time-series-traveling data output from the detection device mounted on the vehicle, even though the leaning vehicle is traveling within the same lane. In the configuration described above, highly accurate traveling data can be acquired in accordance with characteristics of the time-series-traveling data in the leaning vehicle, independently of an action of the installer who mounts the detection device on the leaning vehicle X. The present teaching is not limited to this example, and the traveling-data-output device 1, 51 is also applicable to other mobile objects. The mobile object to which the traveling-data-output device 1, 51 is appliable is herein especially a mobile object that moves in one direction and takes a predetermined posture at the start and end of movement. In particular, the mobile object includes a mobile object in which the gravity acts in the downward direction along the top-bottom axis of the mobile object in a straight-traveling state. The mobile object includes a land-based mobile object, a waterborne mobile object, an underwater mobile object, and an airborne mobile object. The mobile object also includes not only a mobile object operated by a pilot or a driver, but also a mobile object that moves autonomously. The mobile object also includes an artificial satellite or a spacecraft that moves on a satellite orbit in a gravitational sphere.

In the above embodiments, the speed change cycle is one cycle of speed change of the leaning vehicle X in which from a predetermined state where the leaning vehicle X stands upright relative to the ground and the speed in the front-rear direction is zero, the leaning vehicle X accelerates and decelerates one or more times, and then, the leaning vehicle X finally stands upright relative to the ground and reaches the predetermined state where the speed in the front-rear direction is zero. The present teaching is not limited to this example, and the leaning vehicle X may be in a state other than being upright or stopped at the start and end of the speed change cycle. That is, the predetermined state may be a state where the leaning vehicle X is traveling at a constant speed. Without any particular limitation, one cycle of speed change in a period from when the mobile object posture and the speed in the front-rear direction change from the predetermined state to when the mobile object posture and the speed in the front-rear direction return to the predetermined state, can be defined as a speed change cycle.

### (Traveling-Data-Measuring-and-Output Device)

The traveling-data-output device may be a portable terminal owned by the driver of the leaning vehicle. In this case, the portable terminal may be implemented as a traveling-data-measuring-and-output device including a traveling-data-output device and a traveling-data-measuring device. The traveling-data-measuring-and-output device may be implemented as a portable terminal Y, for example. The traveling-data-measuring-and-output device includes the traveling-data-output processor 10, the measurement processor 50, and the detection device 30 incorporated in the portable terminal Y attached to the leaning vehicle X. The traveling-data-output processor and the measurement processor may be constituted by a single processor that is electrically connected to a memory and housed in a casing mounted on the mobile object. The traveling-data-output processor and the measurement processor may be individually implemented by dedicated processing devices.

The single processor may be configured to perform the following processes.
(1) A process of acquiring time-series-traveling data including time-series speed data of the mobile object, acceleration data in the three coordinate axial directions in the coordinate system of the acceleration sensor output from the detection device in a time-series manner, and angular velocity data about the three coordinate axes in the coordinate system of the angular velocity sensor, while the mobile object is traveling in the mobile object posture at the mobile object speed according to the free will of the installer, rather than in the mobile object posture at the mobile object speed instructed in advance, in a state where the casing is mounted on the mobile object in the mounting posture according to the free will of the installer, rather than in the mounting posture instructed in advance by the installer.
(2) A process of outputting, to the memory, the time-series-traveling data including at least a speed change cycle from when the mobile object posture and the mobile object speed in the front-rear direction change from the predetermined state to when the mobile object posture and the mobile object speed in the front-rear direction return to the predetermined state while the mobile object is traveling in the mobile object posture at the mobile object speed according to the free will of the installer, rather than in the mobile object posture at the mobile object speed instructed in advance, in the acquired time-series-traveling data, in a format in which the coordinate systems of the acceleration sensor and the angular velocity sensor are allowed to be subjected to coordinate system conversion by the traveling-data-output processor, rather than in a format in which the time-series-traveling data is subjected to coordinate system conversion to convert the coordinate systems of the acceleration sensor and the angular velocity sensor to the coordinate system of the mobile object.
(3) A process of acquiring the time-series-traveling data for at least the speed change cycle from the memory.
(4) A process of performing coordinate system conversion on the acquired time-series-traveling data for at least the speed change cycle to convert the coordinate systems of the acceleration sensor and the angular velocity sensor to the coordinate system of the mobile object and outputs the resulting time-series-traveling data, by using both the time-series-traveling data when the mobile object posture and the mobile object speed in the front-rear direction change from the predetermined state and the time-series-traveling data when the mobile object posture and the mobile object speed in the front-rear direction return to the predetermined state in the acquired time-series-traveling data for at least the speed change cycle, such that the three coordinate axes in the coordinate systems of the acceleration sensor and the angular velocity sensor are made parallel to or coincident with the three coordinate axes in the coordinate system of the mobile object and that a front-rear direction, a top-bottom direction, and a left-right direction relative to the acceleration sensor and the angular velocity sensor are aligned with a front-rear direction, a top-bottom direction, and a left-right direction relative to the mobile object, whereby the coordinate system conversion is performed based on the time-series-traveling data for at least the speed change cycle acquired during traveling in the mobile object posture at the mobile object speed according to the free will of the installer by the detection device mounted in the mounting posture according to the free will of the installer, unlike data acquired by the detection device mounted in the mounting posture instructed in advance and data acquired by the detection device before start of traveling in the mobile object posture instructed in advance.

The configuration described above can provide the traveling-data-measuring-and-output device having both the function of the traveling-data-output device and the function of the traveling-data-measuring device. Accordingly, the coordinate conversion process can be performed by the traveling-data-measuring-and-output device alone. In addition, without the need to communicate between the traveling-data-measuring device and the traveling-data-output device, influence of the network can thus be avoided.

On the other hand, the present teaching is not limited to this example, and the traveling-data-output processor and the sensor may be mounted on different devices that communicate with each other via the network. That is, the traveling-data-output processor may be a traveling-data-output processor included in a computation processing device that acquires speed data, acceleration data, and angular velocity data from a sensor via communication. Accordingly, the computation processing device that acquires speed data, acceleration data, and angular velocity data from the sensor attached to the leaning vehicle via communication can perform a computation process of generating coordinate-converted data from detection data of the sensor.

In the above embodiments, the GPS mounted on the portable terminal Y detects positioning data such as the speed, position, and bearing of the leaning vehicle X. The present teaching is not limited to this example, positioning data may be detected by other positioning satellite systems collectively referred to as global navigation satellite systems (GNSSs).

In the above embodiments, the coordinate-conversion-data generator 12 separates the turning scene and the straight scene included in the time-series-traveling data in the axial-alignment-and-direction-alignment process for each axis. In addition, the coordinate-conversion-data generator 12 performs axial-alignment-and-direction-alignment process for each axis on at least one of the turning scene or the straight scene. The present teaching is not limited to this example, and the time-series-traveling data may include only the straight scene. Accordingly, in the case where the time-series-traveling data includes only the straight scene, the roll-axis-alignment processor of the first embodiment and the first processor of the roll-axis-alignment processor of the second embodiment can perform axial alignment process of the roll axis without determination of the straight scene.

In the above embodiments, the coordinate-conversion-data generator 12 calculates an average of acceleration data during stopping and traveling of the leaning vehicle X to obtain a gravitational acceleration and specifies a gravity direction. Alternatively, the coordinate-conversion-data generator may specify a gravity direction by extracting only acceleration data during stopping of the leaning vehicle and obtaining a direction in which the gravitational acceleration acts in this state. The coordinate-conversion-data generator may specify a gravity direction by extracting only the acceleration data during traveling of the leaning vehicle and obtaining a direction in which the gravitational acceleration acts in this state. In a case where it is unnecessary to obtain the magnitude of the gravitational acceleration, the coordinate-conversion-data generator may obtain the gravity direction and orientation of the gravity direction by calculating the sum of acceleration data during stopping and traveling of the leaning vehicle X.

In the above embodiments, the coordinate-conversion-data generator 12 determines that the leaning vehicle X is traveling straight if a change in position detected by the GPS is larger than a predetermined speed and a combined angular velocity obtained by the angular velocity data is less than a predetermined angular velocity. Alternatively, the coordinate-conversion-data generator may determine the speed of the leaning vehicle based on a parameter other than a change in position detected by the GPS. The coordinate-conversion-data generator may determine that the leaning vehicle is traveling straight based on a parameter other than the vehicle speed and the combined angular velocity. The coordinate-conversion-data generator may determine that the leaning vehicle is traveling straight by combining at least one of the vehicle speed or the combined angle with another parameter.

In the above embodiments, the coordinate-conversion-data generator 12 specifies the front-rear direction of the roll axis by using the angular velocity about the yaw axis and the angular velocity about the roll axis. Alternatively, the coordinate-conversion-data generator may specify the front-rear direction of the roll axis by using other data including the angular velocity about the pitch axis.

In the above embodiments, the leaning-vehicle-coordinate-system-first axis is the top-bottom axis (yaw axis) extending in the top-bottom direction in the coordinate system of the leaning vehicle X. The present teaching is not limited to this example, and the leaning-vehicle-coordinate-system-first axis may be the front-rear axis (roll axis) extending in the front-rear direction in the coordinate system of the leaning vehicle X.

In the above embodiments, the traveling-data-output processor 10 included in the traveling-data-output device 51 performs a conversion process in the order of the axial-alignment-and-direction-alignment process of the yaw axis, the axial alignment process of the roll axis, and the direction alignment process of the roll axis. The present teaching is not limited to this example, and the traveling-data-output processor may perform the direction alignment process of each axis after performing the axial alignment process of each axis. That is, in the state where the sensor-coordinate-system-first axis is made parallel to or coincident with the mobile-object-coordinate-system-first axis, the traveling-data-output processor may make the remaining coordinate axes other than the sensor-coordinate-system-first axis in the three coordinate axes in the coordinate system of the sensor parallel to or coincident with the remaining coordinate axes other than the mobile-object-coordinate-system-first axis in the three coordinate axes in the coordinate system of the mobile object.

In the configuration described above, axial alignment is first performed on one coordinate axis, and then on the other coordinate axes. This makes computation easier than in the case of performing axial alignment on the three coordinate axes collectively. In addition, after axial alignment of the three coordinate axes has been performed, direction alignment of the three aligned coordinate axes is performed. This makes computation easier than that in the case of performing axial alignment and direction alignment collectively.

The order of the axial alignment process of each axis and the direction alignment process of each axis is not limited to the order described above, and is arbitrary.

In the second embodiment, the bearing angle θ2 with respect to the geomagnetic bearing M1 is an angle between the geomagnetic bearing M1 and the sensor-coordinate-system-roll axis Mx. The present teaching is not limited to this example, and the bearing angle with respect to the direction of a magnetic flux line may be expressed as an angle between the direction of the magnetic flux line and the sensor-coordinate-system-pitch axis.

In the second embodiment, for example, the traveling data acquirer 11 calculates a geomagnetic bearing, which is a horizontal component relative to the ground, among the three axial directions of the magnetic flux lines, based on accelerations included in the time-series-traveling data D1. The GPS bearing data D24 generated by the traveling data acquirer 11 includes the bearing angle θ1 calculated based on a change in position detected by the GPS. The present teaching is not limited to this example, and the traveling data acquirer 11 may calculate the bearing based on detection data of sensors included in the detection device 30 by other techniques.

For example, in a case where the sensors include an IMU including an acceleration sensor and an angular velocity sensor, and a geomagnetic sensor, the traveling data acquirer 11 may calculate a bearing based on a combination of detection data of the acceleration, the angular velocity, and the geomagnetism. In the case where the sensors include either an acceleration sensor or an angular velocity sensor, and a geomagnetic sensor, the traveling data acquirer 11 may calculate a bearing based on a combination of detection data of the acceleration or the angular velocity and detection data of the geomagnetism. The detection data of the geomagnetism may be corrected by, for example, a Kalman filter to be combined with detection data of one or both of the acceleration and the angular velocity. Accordingly, errors in calculating the bearing can be reduced.

In a case where the sensors include an IMU including an acceleration sensor and an angular velocity sensor, the traveling data acquirer 11 may calculate the bearing based on a combination of detection data of the acceleration and detection data of the angular velocity.

In the above embodiments, the coordinate-converted data output from the traveling-data-output device 1 may be used for data processing related to traveling of the leaning vehicle X in analyzing leaning-vehicle-traveling data that is traveling data of the leaning vehicle X, in generating turning evaluation data related to at least one of agility or smoothness during turning of the leaning vehicle X, or in estimating a behavior during traveling of the leaning vehicle, for example.

The leaning-vehicle-traveling data is data related to traveling of the leaning vehicle X. The leaning-vehicle-traveling data may include at least one of leaning-vehicle-driving-input data related to a driving input to the leaning vehicle by a driver, leaning-vehicle-behavior data related to a behavior of the leaning vehicle, leaning-vehicle-position data related to a traveling position of the leaning vehicle, or leaning-vehicle-traveling-environment data related to a traveling environment in which the leaning vehicle travels. The leaning-vehicle-traveling data may include data other than the leaning-vehicle-driving-input data, the leaning-vehicle-behavior data, the leaning-vehicle-position data, and the leaning-vehicle-traveling-environment data. The leaning-vehicle-traveling data may include one or more of the leaning-vehicle-driving-input data, the leaning-vehicle-behavior data, the leaning-vehicle-position data, and leaning-vehicle-traveling-environment data.

The leaning-vehicle-driving-input data is data related to an operation input of the driver performed when the driver drives the leaning vehicle. Specifically, the leaning-vehicle-driving-input data may include data related to an accelerator operation, a brake operation, gear shift operations (operation of a clutch lever and operation of a shift pedal), a change in the position of the center of gravity due to steering or a posture change of the driver, and so forth. Specifically, the leaning-vehicle-driving-input data may include data related to operations of switches such as a horn switch, a winker switch, and a lighting switch, and other operations. The leaning-vehicle-behavior data is data related to a behavior of the leaning vehicle caused by a driving input of the driver when the leaning vehicle is driven by the driver. Specifically, the leaning-vehicle-behavior data includes an acceleration, a speed, and an angle of the leaning vehicle that change when the driver drives the leaning vehicle. That is, the leaning-vehicle-behavior data is data expressing a behavior of the leaning vehicle occurring in the case of accelerating or decelerating the leaning vehicle when the driver performs an accelerator operation, a brake operation, or a gear shift operation, the case of performing a posture change including steering of the leaning vehicle and a change of the center of gravity, and other cases.

The leaning-vehicle-behavior data is not limited to the data related to the acceleration, the speed, and the angle of the leaning vehicle as described above, and may include operations occurring in the leaning vehicle when the driver performs a switch operation and other operations on the leaning vehicle. That is, the leaning-vehicle-behavior data includes data related to operations occurring in the leaning vehicle due to operations of switches such as a horn switch, a winker switch, and a lighting switch and other operations.

The leaning-vehicle-position data is data related to a traveling position of a leaning vehicle. For example, the leaning-vehicle-position data can be detected based on information from a GPS, or a communication base station of a communication portable terminal. The leaning-vehicle-position data can be calculated by various positioning techniques, simultaneous localization and mapping (SLAM), and other techniques.

The leaning-vehicle-traveling-environment data includes map data, for example. The map data may be associated with information on road situations, information on road traffic environments such as signals and facilities, regulation information on traveling on roads, and other information. The map data may be associated with environmental data such as weather, temperature, and humidity. The leaning-vehicle-traveling-environment data can be used for analysis of a driving skill and a driving tendency of the driver and other purposes, together with the leaning-vehicle-driving-input data, the leaning-vehicle-behavior data, and the leaning-vehicle-position data.

The agility in the turning evaluation data refers to a motion of the leaning vehicle in a case where an actual turning motion of the leaning vehicle corresponds to a turning motion predicted based on the will of the driver in order to obtain a turning force of the leaning vehicle while the leaning vehicle is traveling on a corner. The smoothness in the turning evaluation data refers to a motion of the leaning vehicle in a case where an actual turning motion of the leaning vehicle corresponds to a turning motion predicted based on the will of the driver while the leaning vehicle is traveling on a corner.

The method for generating the turning evaluation data is similar to the method disclosed in International Patent Publication No. 2021/079494, for example.

The computation processing device can accurately acquire and process data related to traveling of the leaning vehicle by using coordinate-converted data output from the traveling-data-output device 1, 51 in data processing related to traveling of the leaning vehicle X, such as in analyzing leaning-vehicle-traveling data that is traveling data of the leaning vehicle X, in generating turning evaluation data related to at least one of agility or smoothness during turning of the leaning vehicle X, or in estimating a behavior during traveling of the leaning vehicle.

The output data output after being processed by the computation processing device may be used for services related to economic losses. The output data may be used for information for theft prevention of the leaning vehicle, abnormality of the leaning vehicle, failure of the leaning vehicle, maintenance of the leaning vehicle, collision prevention, improvement of a traveling environment, route guidance, presentation of information to the driver, and so forth.

### REFERENCE SIGNS LIST

1, 51 traveling-data-output device
10 traveling-data-output processor
11 traveling data acquirer
12 coordinate-conversion-data generator
121 yaw axis processor
122 roll-axis-alignment processor
1221 first processor
1222 second processor
123 roll-axis-direction-alignment processor
1231 first processor
1232 second processor
1233 third processor
13 output section
20 memory
30 sensor
D1 time-series-traveling data
D21 speed data
D22 acceleration data
D23 angular velocity data
D24 GPS bearing data
D25 geomagnetic bearing data
D3 coordinate-converted data
X leaning vehicle
Xa vehicle body
Y portable terminal

The invention claimed is:

1. A traveling-data-output device for outputting traveling data of a first coordinate system, which is a coordinate system of a mobile object, based on an output of a detection device that is mounted and fixed to the mobile object by an installer and that detects a physical quantity related to a behavior of the mobile object, the detection device including:
an acceleration sensor configured to output accelerations in three directions respectively in three coordinate axes of a second coordinate system, which is a coordinate system of the acceleration sensor, the acceleration sensor being mounted on the mobile object in a first mounting posture according to a free will of the installer rather than in a predetermined first mounting posture instructed in advance, and
an angular velocity sensor configured to output angular velocities about three coordinate axes of a third coordinate system, which is a coordinate system of the angular velocity sensor, the angular velocity sensor being mounted on the mobile object in a second mounting posture thereof according to the free will of the installer rather than in a predetermined second mounting posture instructed in advance,
the traveling-data-output device comprising:
a traveling-data-output processor configured to execute program instructions to:
acquire at least time-series-traveling data that is output in a time-series manner from the detection device for a speed change cycle, the speed change cycle being from when a posture of the mobile object and a speed of the mobile object in a front-rear direction of the mobile object change from a predetermined state to when the posture and the speed of the mobile object in the front-rear direction return to the predetermined state while the mobile object is traveling in the posture at the speed according to the free will of the installer rather than in a predetermined posture and at a predetermined speed instructed in advance, the time-series-traveling data including:
speed data of the mobile object,
acceleration data in the three directions in the second coordinate system, and
angular velocity data about the three coordinate axes in the third coordinate system, and
perform coordinate system conversion on the acquired time-series-traveling data for at least the speed change cycle to convert the second and third coordinate systems to the first coordinate system and output the resulting time-series-traveling data, by using at least both
the time-series-traveling data when the posture and the speed of the mobile object in the front-rear direction change from the predetermined state, and
the time-series-traveling data when the posture and the speed of the mobile object in the front-rear direction return to the predetermined state,
in the acquired time-series-traveling data for the speed change cycle, such that
the three coordinate axes in each of the second and third coordinate systems are made parallel to or coincident with three coordinate axes in the first coordinate system, and
a front-rear direction, a top-bottom direction, and a left-right direction relative to each of the acceleration sensor and the angular velocity sensor are aligned with the front-rear direction, a top-bottom direction, and a left-right direction relative to the mobile object, whereby
the coordinate system conversion is performed based on the acquired time-series-traveling data for at least the speed change cycle acquired during traveling in the posture at the speed according to the free will of the installer by the detection device mounted in the first and second mounting postures according to the free will of the installer, unlike data acquired by the detection device mounted in the predetermined first and second mounting postures instructed in advance and data acquired by the detection device before start of traveling in the predetermined posture instructed in advance.

2. The traveling-data-output device according to claim 1, wherein
the traveling-data-output processor makes a sensor-coordinate-system-first axis that is one of the three coordinate axes in the second or third coordinate system parallel to or coincident with a mobile-object-coordinate-system-first axis that is one of the three coordinate axes in the first coordinate system.

3. The traveling-data-output device according to claim 2, wherein
the traveling-data-output processor
aligns a direction of the sensor-coordinate-system-first axis with a direction of the mobile-object-coordinate-system-first axis
in a state where the sensor-coordinate-system-first axis is made parallel to or coincident with the mobile-object-coordinate-system-first axis.

4. The traveling-data-output device according to claim 3, wherein
the traveling-data-output processor
makes remaining coordinate axes other than the sensor-coordinate-system-first axis in the three coordinate axes in the second or third coordinate systems parallel to or coincident with remaining coordinate axes other than the mobile-object-coordinate-system-first axis in the three coordinate axes in the first coordinate system, respectively, and aligns directions of the remaining coordinate axes other than the sensor-coordinate-system-first axis with directions of the remaining coordinate axes other than the mobile-object-coordinate-system-first axis, respectively
in a state where the sensor-coordinate-system-first axis is made parallel to or coincident with the mobile-object-coordinate-system-first axis and the direction of the sensor-coordinate-system-first axis is aligned with the direction of the mobile-object-coordinate-system-first axis.

5. The traveling-data-output device according to claim 2, wherein
the traveling-data-output processor
makes remaining coordinate axes other than the sensor-coordinate-system-first axis in the three coordinate axes in the second or third coordinate system parallel to or coincident with remaining coordinate axes other than the mobile-object-coordinate-system-first axis in the three coordinate axes in the first coordinate system
in a state where the sensor-coordinate-system-first axis is made parallel to or coincident with the mobile-object-coordinate-system-first axis.

6. The traveling-data-output device according to claim 2, wherein
the mobile-object-coordinate-system-first axis is a top-bottom axis extending in the top-bottom direction in the first coordinate system or a front-rear axis extending in the front-rear direction in the first coordinate system.

7. The traveling-data-output device according to claim 4, wherein
the mobile-object-coordinate-system-first axis is a top-bottom axis extending in the top-bottom direction in the first coordinate system, and
the traveling-data-output processor
makes a sensor-coordinate-system-second axis that is one of the remaining coordinate axes in the second or third coordinate system parallel to or coincident with a front-rear axis extending in the front-rear direction in the first coordinate system, whereby
a direction of the sensor-coordinate-system-second axis is aligned with a direction of the front-rear axis in the first coordinate system
in a state where the sensor-coordinate-system-first axis is made parallel to or coincident with the top-bottom axis in the first coordinate system, and the direction of the sensor-coordinate-system-first axis is aligned with a direction of the top-bottom axis in the first coordinate system.

8. A traveling-data-measuring device for the traveling-data-output device of claim 1, the traveling-data-measuring device being configured to be mountable on the mobile object and measure the time-series-traveling data for at least the speed change cycle for use in the coordinate system conversion, the traveling-data-measuring device comprising:
the detection device including the acceleration sensor and the angular velocity sensor; and
a measurement processor, which is configured to execute other program instructions to:
acquire the time-series-traveling data in the time-series manner from the detection device, including:
the speed data of the mobile object,
the acceleration data in the three coordinate axial directions in the second coordinate system, and
the angular velocity data about the three coordinate axes in the third coordinate system,
while the mobile object is traveling in the posture at the speed according to the free will of the installer rather than in the predetermined posture and at the predetermined speed instructed in advance, in a state where the traveling-data-measuring device is mounted on the mobile object in a third mounting posture according to the free will of the installer rather than in a predetermined third mounting posture instructed in advance by the installer, and
output the time-series-traveling data of at least the speed change cycle from when the posture and the speed of the mobile object in the front-rear direction change from the predetermined state to when the posture and the speed in the front-rear direction return to the predetermined state while the mobile object is traveling in the posture at the speed according to the free will of the installer rather than in the predetermined posture and at the predetermined speed instructed in advance, in the acquired time-series-traveling data, in a format in which the second and third coordinate systems are allowed to be subjected to coordinate system conversion by the traveling-data-output processor of the traveling-data-output device, rather than in a format in which the time-series-traveling data is subjected to coordinate system conversion to convert the second and third coordinate systems to the first coordinate system.

9. The traveling-data-measuring device according to claim 8, further comprising a communication device configured to communicate with outside, wherein
the measurement processor outputs, to outside of the traveling-data-measuring device via the communication device, the time-series-traveling data.

10. A traveling-data-output device according to claim 1, further comprising a communication device configured to communicate with outside, wherein
the traveling-data-output processor acquires the time-series-traveling data for at least the speed change cycle via the communication device.

11. A traveling-data-measuring-and-output device for outputting traveling data of a first coordinate system, which is a coordinate system of a mobile object, based on an output of a detection device that is mounted and fixed to the mobile object by an installer and that detects a physical quantity related to a behavior of the mobile object, the detection device including:
an acceleration sensor configured to output accelerations in three directions respectively in three coordinate axes of a second coordinate system, which is a coordinate system of the acceleration sensor, the acceleration sensor being mounted on the mobile object in a first mounting posture according to a free will of the installer rather than in a predetermined first mounting posture instructed in advance, and
an angular velocity sensor configured to output angular velocities about three coordinate axes of a third coordinate system, which is a coordinate system of the angular velocity sensor, the angular velocity sensor being mounted on the mobile object in a second mounting posture thereof according to the free will of the installer
rather than in a predetermined second mounting posture instructed in advance, the traveling-data-measuring and output device comprising:
a processor that is electrically connected to a memory and housed in a casing mounted on a mobile object, wherein
the processor is configured to execute program instructions to:
acquire time-series-traveling data that is output in a time-series manner from the detection device, the time-series-traveling data including speed data of the mobile object,
acceleration data in the three directions of the second coordinate system, and
angular velocity data about the three coordinate axes of the third coordinate system,
while the mobile object is traveling in a posture at a speed according to the free will of an installer rather than in a predetermined posture and at a predetermined speed instructed in advance, in a state where the casing is mounted on the mobile object in a third mounting posture according to the free will of the installer rather than in a predetermined third mounting posture instructed in advance by the installer,
output, to the memory, the time-series-traveling data including data for at least a speed change cycle, which is from when a posture and a speed of the mobile object in a front-rear direction change from a predetermined state to when the posture and the speed of the mobile object in the front-rear direction return to the predetermined state, while the mobile object is traveling in the posture at the speed according to the free will of the installer rather than in the predetermined posture and at the predetermined speed instructed in advance in the acquired time-series-traveling data, in a format in which the second and third coordinate systems are allowed to be subjected to coordinate system conversion by the processor, rather than in a format in which the time-series-traveling data is subjected to coordinate system conversion to convert the second and third coordinate systems to the first coordinate system,
acquires the time-series-traveling data for at least the speed change cycle from the memory, and
perform the coordinate system conversion on the acquired time-series-traveling data for at least the speed change cycle to convert the second and third coordinate systems to the first coordinate system and output the time-series-traveling data, by using both the time-series-traveling data when the posture and the speed of the mobile object in the front-rear direction change from the predetermined state and the time-series-traveling data when the posture and the speed of the mobile object in the front-rear direction return to the predetermined state in the acquired time-series-traveling data for at least the speed change cycle, such that
the three coordinate axes in each of the second and third coordinate systems are made parallel to or coincident with the three coordinate axes in the first coordinate system, and
a front-rear direction, a top-bottom direction, and a left-right direction relative to each of the acceleration sensor and the angular velocity sensor are aligned with the front-rear direction, a top-bottom direction, and a left-right direction relative to the mobile object, whereby
the coordinate system conversion is performed based on the acquired time-series-traveling data for at least the speed change cycle acquired during traveling in the posture at the speed according to the free will of the installer by the detection device mounted in the first and second mounting postures according to the free will of the installer, unlike data acquired by the detection device mounted in the predetermined first and second mounting postures instructed in advance and data acquired by the detection device acquired before start of traveling in the predetermined posture instructed in advance.

12. A leaning-vehicle-data-processing device, comprising:
the traveling-data-measuring and output device according to claim 11, wherein
the mobile object includes a leaning vehicle having a vehicle body that leans leftward when turning to left and leans rightward when turning to right,
the time-series-traveling data for at least the speed change cycle acquired by the traveling-data-output processor and used for coordinate system conversion is time-series-traveling data for a speed change cycle acquired while the mobile object is traveling in the posture at the speed according to the free will of the installer rather than in the predetermined posture and at the predetermined speed instructed in advance and from when the posture of the mobile object including at least a leaning posture related to a left-right direction of the mobile object and the speed in the front-rear direction change from the predetermined state to when the posture and the speed return to the predetermined state, and
the coordinate system conversion is performed by using the time-series-traveling data for at least the speed change cycle including at least a change of the leaning posture related to the left-right direction of the mobile object.
